(19) United States
(12) Patent Application Publication
(10) Pub. No.: US 2019/0165363 A1
(43) Pub. Date: May 30, 2019

(54) Graphene Foam-Protected Niobium-Based Composite Metal Oxide Anode Active Materials for Lithium Batteries

(71) Applicant: Nanotek Instruments, Inc., Dayton, OH (US)

(72) Inventors: Aruna Zhamu, Springboro, OH (US); Bor Z. Jang, Centerville, OH (US)

(73) Assignee: Nanotek Instruments, Inc., Dayton, OH (US)

(21) Appl. No.: 15/822,871

(22) Filed: Nov. 27, 2017

(51) Int. Cl. H01M 4/133; H01M 4/131; H01M 10/0525; C01G 33/00; C01B 32/182

(52) U.S. Cl. CPC H01M 4/133; H01M 4/131; H01M 2004/027; C01G 33/00; C01B 32/182; H01M 10/0525

(57) ABSTRACT

A lithium-ion battery anode layer, comprising an anode active material embedded in pores of a solid graphene foam composed of multiple pores and pore walls, wherein (a) the pore walls contain a pristine graphene or a non-pristine graphene material; (b) the anode active material contains particles of a niobium-containing composite metal oxide and is in an amount from 0.5% to 99% by weight based on the total weight of the graphene foam and the anode active material combined, and (c) the multiple pores are lodged with particles of the anode active material. Preferably, the solid graphene foam has a density from 0.01 to 1.7 g/cm³, a specific surface area from 50 to 2,000 m²/g, a thermal conductivity of at least 100 W/mK per unit of specific gravity, and/or an electrical conductivity no less than 1,000 S/cm per unit of specific gravity.

### FIELD OF THE INVENTION

The present invention relates generally to the field of rechargeable lithium battery and, more particularly, to the anode layer containing a new group of graphene foam-protected niobium oxide anode active materials and the process for producing same.

### BACKGROUND OF THE INVENTION

The past two decades have witnessed a continuous improvement in Li-ion batteries in terms of energy density, rate capability, and safety. However, current Li-ion batteries still fall sort in rate capability, requiring long recharge times (e.g. several hours for electric vehicle batteries), and inability to deliver high pulse power (power density<<1 kW/kg).

Conventional lithium-ion batteries generally make use of an anode (negative electrode) active material (e.g. graphite and hard carbon particles) that has an electrochemical potential poorly matched to the potential level at which the electrolyte is reduced, which results in a lower capacity and may introduce an internal short-circuit that sets the electrolyte on fire unless charging rates are controlled.

Conventional lithium-ion batteries are designed so that the electrolyte has an electrochemical potential window between its LUMO (lowest unoccupied molecular orbital) and HOMO (highest occupied molecular orbital). This window is typically between 1.1 and 4.3 eV below the Fermi energy (electrochemical potential) of elemental Lithium. Conventional lithium-ion batteries also have an open-circuit voltage described by the equation: V_{OC}=(E_{FA}−E_{FC})/e where E_{FA} is the Fermi energy of the anode, E_{FC} is the Fermi energy of the cathode, and e is the magnitude of the charge of an electron. If E_{FA} lies above the LUMO energy level of the electrolyte, the electrolyte will be reduced during the battery operation unless a passivation layer forms on the anode material surface. Such a solid-electrolyte interphase (SEI) passivation layer contains elemental Lithium (Li⁰) in order not to block the transfer of lithium ions through the SEI.

When a lithium-ion battery is charged, lithium ions are transferred from the electrolyte to the anode. Electrons (e⁻) are also concurrently transferred to the anode from an external circuit. Higher voltages can be used to charge batteries more quickly, but if the fast-charging voltage raises the energy of the incoming electrons above the Fermi energy (electrochemical potential) of metallic lithium, the lithium ions will inhomogeneously plate out of the electrolyte onto the anode as elemental Lithium. Consequently, the anode can develop a mossy surface and, eventually, a lithium dendrite can grow through the electrolyte to the cathode, causing internal shorting and possibly a fire and explosion.

To prevent such shorting issues, carbon/graphite is typically used as the anode active material into which lithium ions are reversibly inserted. Insertion of lithium ions into carbon/graphite is a two phase reaction from C to LiC₆ and provides a voltage plateau of approximately 0.2 V versus Li⁺/Li⁰. However, the electrochemical potential of reduced carbon/graphite is above the electrolyte LUMO and thus carbon/graphite anodes form a passivating SEI layer. This layer increases the impedance of the anode, consumes some amount of lithium irreversibly from the cathode on the initial charge, and limits the charging voltage (thus, the charging rate). If the cell is charged too rapidly (typically at a voltage of 1.0 V versus) Li⁺/Li⁰, lithium ions are not able to traverse the SEI layer before they are plated out on the surface of the SEI layer as elemental Lithium. This problem limits the charging rate of a battery and may require additional protective circuitry against internal shorting. In addition, the capacity of the cathode normally limits the capacity of a cell, and the entrapment of lithium in the anode SEI layer during charge can reduce the capacity of the cathode and the amount of energy stored in the cell.

An alternative anode active material is the spinel Li₄Ti₅O₁₂, which operates on the Ti(IV)/Ti(III) redox couple located at 1.5 V versus Li⁺/Li⁰. This anode material is capable of a fast charge and a long cycle life due to no SEI layer formation and minimal volume changes during repeated charges/discharges. However, the material has a low specific capacity (theoretically 175 mAh/g and practically 120-150 mAh/g). In comparison with a carbon/graphite anode material (theoretically 372 mAh/g and practically 320-360 mAh/g; having an intercalation/desorbing potential at 0.2 V versus Li⁺/Li⁰), the Li₄Ti₅O₁₂ material suffers a voltage loss of 1.3 V (=1.5V−0.2 V) and a capacity reduction of approximately 200 mAh/g, resulting in a significantly lower energy density of a battery using such a titanium oxide-based anode.

Therefore, there is a need for an anode material having a higher capacity than Li₄Ti₅O₁₂ and having a voltage in the range of 1.1V-1.5 V versus Li⁺/Li⁰. In response to this need, new electrode materials containing Nb oxide have been examined and some of these materials are found to have a high charging and discharging capacity. For instance, a titanium-niobium composite oxide represented by a general formula TiNb₂O₇ has a high theoretical capacity that exceeds 300 mAh/g. Previous work on Nb-based composite metal oxide may be found in the following references:
1. L. Burnnie, et al. U.S. Pat. No. 9,698,417 (Jul. 4, 2017).
2. Y. Harada, et al. U.S. Pat. No. 9,240,590 (Jan. 19, 2016); Y. Harada, et al. U.S. Pat. No. 9,515,319 (Dec. 6, 2016); Y. Harada, et al. U.S. Pat. No. 9,136,532 (Sep. 15, 2015).
3. H. Inagaki, et al. U.S. Pat. No. 9,240,591 (Jan. 19, 2016); H. Inagaki, et al. U.S. Pat. No. 9,774,032 (Sep. 26, 2017); H. Inagaki, et al. U.S. Pat. No. 9,325,002 (Apr. 26, 2016); H. Inagaki, et al. U.S. Pat. No. 9,431,657 (Aug. 30, 2016).
4. S. Dai, et al. U.S. Pat. No. 9,806,338 (Oct. 31, 2017).
5. J. B. Goodenough, et al. U.S. Pat. No. 8,647,773 (Feb. 11, 2014).
6. K. Yoshima, et al. U.S. Pat. No. 9,373,841 (Jun. 21, 2016).
7. K. Nakahara, et al. U.S. Pat. No. 9,806,339 (Oct. 31, 2017).
8. Sundaramurthy Jayaraman, et al., “Exceptional Performance of TiNb₂O₇ Anode in All One-Dimensional Architecture by Electrospinning,” ACS Appl. Mater. Interfaces, 2014, 6 (11), pp 8660-8666.
9. Bingkun Guo, et al., “A long-life lithium-ion battery with a highly porous TiNb₂O₇ anode for large-scale electrical energy storage,” Energy Environ. Sci., 2014, 7, 2220-2226.
10. Chunfu Lin, et al, “Nano-TiNb₂O₇/carbon nanotubes composite anode for enhanced lithium-ion storage,” Electrochimica Acta, Volume 260, 10 Jan. 2018, Pages 65-72
11. S. Lou, et al. “Facile synthesis of nanostructured TiNb₂O₇ anode materials with superior performance for high-rate lithium ion batteries,” Chem Commun (Camb). 2015 Dec. 18; 51(97):17293-6.
12. Taeseup Song, et al., “Porosity-Controlled TiNb₂O₇ Microspheres with Partial Nitridation as A Practical Negative Electrode for High-Power Lithium-Ion Batteries,” Advanced Energy Materials, Volume 5, Issue 8, Apr. 22, 2015, 1401945.

However, for all known transition metal oxides operating with a potential of about 1.1-1.5 V vs. Li⁺/Li⁰, it has been found difficult to form a stable film and decomposition of the electrolyte continues to occur on the electrode active material or electrode surface when the battery undergoes repeated charges/discharges. All these Nb-based composite metal oxide compositions fall short in terms of reaching their theoretical lithium ion storage capacities and having a long cycle life.

Clearly, an urgent need exists for an effective approach to protecting niobium-containing composite metal oxide-based anode active materials that operate at a voltage in the range of 1.1V-1.5 V versus Li⁺/Li⁰ with minimal repeated loss of capacity due to electrolyte decomposition and repeated SEI formation. Such an approach provides a high active material utilization rate, high specific capacity at both high and low charge/discharge rates (not just at a low rate), high rate capability, long cycle-life, and improved heat dissipation generated during a battery operation. These are the main objectives of the instant invention.

### SUMMARY OF THE INVENTION

Herein reported is a process for producing a significantly improved anode layer that provides not only a robust 3-D network of electron-conducting paths and high conductivity, but also enables the anode material to be readily made into an electrode layer with a high electrode tap density, a sufficiently large electrode thickness (typically 50-500 μm to ensure a sufficient amount of output current), a large weight percentage of anode active material (with respect to the total amount of the non-active materials, such as conductive additive and binder, in an electrode and a separate current collector combined), and long-term cycling stability. Both the reversible capacity and the first-cycle efficiency are also significantly improved over those of state-of-the-art anode materials.

Briefly, the present invention provides a new anode layer composition wherein an anode active material (a niobium-containing composite metal oxide, such as TiNb₂O₇ particles) is naturally lodged in pores of a graphene foam. This graphene foam also exhibits a unique “elastic” property in that the cell walls (solid portion of the foam) can be compressed to tightly embrace anode active material particles when an anode layer is made. When individual particles expand (upon Li intercalation), the volume expansion is accommodated by local cell walls, without inducing a volume change of the entire anode layer (hence, not exerting internal pressure to the battery). During the subsequent discharge cycle, these particles shrink; yet the local cell walls shrink or snap back in a congruent manner, maintaining a good contact between cell walls and the particles (remaining capable of accepting Li⁺ ions and electrons during the next charge cycle).

More significantly, the graphene walls prevent the niobium-containing composite metal oxide from making direct physical contact with any liquid component of an electrolyte so that there is little or no continued electrochemical decomposition of electrolyte and consumption of lithium ions and, hence, no rapid decay of the lithium ion storage capacity of a lithium-ion battery.

The invented anode or negative electrode layer comprises an anode active material embedded in pores of a solid graphene foam composed of multiple pores and pore walls, wherein (a) the pore walls contain a pristine graphene material (defined as having essentially zero % or less than 0.01%) of non-carbon elements) or a non-pristine graphene material (defined as having at least 0.01% by weight of non-carbon elements), preferably having less than 5% by weight of non-carbon elements, wherein the non-pristine graphene is selected from graphene oxide, reduced graphene oxide, graphene fluoride, graphene chloride, graphene bromide, graphene iodide, hydrogenated graphene, nitrogenated graphene, boron-doped graphene, nitrogen-doped graphene, chemically functionalized graphene, or a combination thereof; (b) the anode active material is in an amount from 0.5% to 99% by weight based on the total weight of the graphene foam and the anode active material combined; and (c) some pores are lodged with the particles of the anode active material and other pores are particle-free, and the graphene foam is sufficiently elastic to accommodate volume expansion and shrinkage of the particles of the anode active material during a battery charge-discharge cycle to avoid an expansion of the anode layer.

The solid graphene foam typically has a density from 0.01 to 1.7 g/cm³, a specific surface area from 50 to 2,000 m²/g, a thermal conductivity of at least 100 W/mK per unit of specific gravity, and/or an electrical conductivity no less than 1,000 S/cm per unit of specific gravity.

In an embodiment, the niobium-containing composite metal oxide may be selected from the group consisting of TiNb₂O₇, LiₓTiNb₂O₇ (0≤x≤5), LiₓM_{(1-y)}Nb_{y}Nb₂O_{(7+δ)}(wherein 0<x≤6, 0≤y≤1, −1≤δ≤1, and M=Ti or Zr), TiₓNb_{y}O₇ (0.5≤y/x<2.0), TiNbₓO_{(2+5x/2)} (1.9≤x<2.0), MₓTi₍₁₋₂ₓ₎Nb₍₂₊ₓ₎O_{(7+δ)}(wherein 0≤x≤0.2, −0.3≤δ≤0.3, and M=a trivalent metal selected from Fe, Ga, Mo, Ta, V, Al, B, and a mixture thereof), MₓTi₍₂₋₂ₓ₎Nb₍₁₀₊ₓ₎O_{(29+δ)}(wherein 0≤x≤0.4, −0.3≤δ≤0.3, and M=a trivalent metal selected from Fe, Ga, Mo, Al, B, and a mixture thereof), MₓTiNb₂O₇ (x<0.5, and M=B, Na, Mg, Al, Si, S, P, K, Ca, Mo, W, Cr, Mn, Co, Ni, and Fe), TiNb₂₋ₓTaₓO_{y} (0≤x<2, 7≤y≤10), Ti₂Nb₁₀₋ᵥTaᵥO_{w} (0≤v<2, 27≤y≤29), LiₓTi_{(1-y)}M1_{y}Nb_{(2-z)}M2_{z}O_{(7+δ)} (wherein 0≤x≤5, 0≤y≤1, 0≤z≤2, −0.3≤δ≤0.3, M1=Zr, Si, and Sn, and M2=V, Ta, and Bi), P-doped versions thereof, B-doped versions thereof, carbon-coated versions thereof, and combinations thereof. In such a niobium-containing composite metal oxide, niobium oxide typically forms the main framework or backbone of the crystal structure, along with at least a transition metal oxide.

Preferably, the anode active material (e.g. niobium-containing composite metal oxide) is in a form of nanoparticle, nanowire, nanofiber, nanotube, nanosheet, nanobelt, nanoribbon, or nanocoating having a thickness or diameter less than 100 nm. More preferably, the anode active material has a dimension less than 20 nm.

In a preferred embodiment, the anode layer further comprises a carbon or graphite material therein, wherein the carbon or graphite material is in electronic contact with or deposited onto the anode active material. Most preferably, this carbon or graphite material embraces the particles of the anode active material and the embraced particles are then lodged in the pores of the graphene foam. The carbon or graphite material may be selected from polymeric carbon, amorphous carbon, chemical vapor deposition carbon, coal tar pitch, petroleum pitch, mesophase pitch, carbon black, coke, acetylene black, activated carbon, fine expanded graphite particle with a dimension smaller than 100 nm, artificial graphite particle, natural graphite particle, or a combination thereof. Most preferably, the anode layer further comprises a conductive protective coating, selected from a carbon material, electronically conductive polymer, conductive metal oxide, conductive metal coating, or a lithium-conducting material, which is deposited onto or wrapped around the nanoparticle, nanowire, nanofiber, nanotube, nanosheet, nanobelt, nanoribbon, or nanocoating. Preferably, the nanoparticle, nanowire, nanofiber, nanotube, nanosheet, nanobelt, nanoribbon, or nanocoating is prelithiated. The coating can be a lithium-conducting material.

Typically, in the invented anode layer, the pore walls contain stacked graphene planes having an inter-plane spacing 4₀₀₂ from 0.3354 nm to 0.36 nm as measured by X-ray diffraction. The pore walls can contain a pristine graphene and the solid graphene foam has a density from 0.5 to 1.7 g/cm³ or the pores have a pore size from 2 nm to 200 nm, preferably from 2 nm to 100 nm. Alternatively, the non-pristine graphene material contains a content of non-carbon elements from 0.01% to 2.0% by weight. In one embodiment, the pore walls contain graphene fluoride and the solid graphene foam contains a fluorine content from 0.01% to 2.0% by weight. In another embodiment, the pore walls contain graphene oxide and the solid graphene foam contains an oxygen content from 0.01% to 2.0% by weight. Typically, the non-carbon elements include an element selected from oxygen, fluorine, chlorine, bromine, iodine, nitrogen, hydrogen, or boron. Typically, the solid graphene foam has a specific surface area from 200 to 2,000 m²/g or a density from 0.1 to 1.5 g/cm³.

In a preferred embodiment, the anode layer is made from a layer that is a continuous-length roll sheet form having a thickness no greater than 300 μm and a length of at least 2 meters and is produced by a roll-to-roll process.

In a desired embodiment, the graphene foam in the anode layer has an oxygen content or non-carbon content less than 1% by weight, and the pore walls have an inter-graphene spacing less than 0.35 nm, a thermal conductivity of at least 250 W/mK per unit of specific gravity, and/or an electrical conductivity no less than 2,500 S/cm per unit of specific gravity.

In a preferred embodiment, the graphene foam has an oxygen content or non-carbon content less than 0.01% by weight and the pore walls contain stacked graphene planes having an inter-graphene spacing less than 0.34 nm, a thermal conductivity of at least 300 W/mK per unit of specific gravity, and/or an electrical conductivity no less than 3,000 S/cm per unit of specific gravity. Further preferably, the graphene foam has an oxygen content or non-carbon content no greater than 0.01% by weight and the pore walls contain stacked graphene planes having an inter-graphene spacing less than 0.336 nm, a mosaic spread value no greater than 0.7, a thermal conductivity of at least 350 W/mK per unit of specific gravity, and/or an electrical conductivity no less than 3,500 S/cm per unit of specific gravity. Most preferably, the graphene foam has pore walls containing stacked graphene planes having an inter-graphene spacing less than 0.336 nm, a mosaic spread value no greater than 0.4, a thermal conductivity greater than 400 W/mK per unit of specific gravity, and/or an electrical conductivity greater than 4,000 S/cm per unit of specific gravity.

The pore walls may contain stacked graphene planes having an inter-graphene spacing less than 0.337 nm and a mosaic spread value less than 1.0. In an embodiment, the solid graphene foam exhibits a degree of graphitization no less than 80% and/or a mosaic spread value less than 0.4. More preferably, the solid graphene foam exhibits a degree of graphitization no less than 90% and/or a mosaic spread value no greater than 0.4. Typically, in the invented anode layer, the pore walls contain a 3D network of interconnected graphene planes. The graphene foam contains pores having a pore size from 20 nm to 500 nm.

The present invention also provides a lithium battery containing the anode or negative electrode as defined above, a cathode or positive electrode, and an electrolyte in ionic contact with the anode and the cathode. A porous separator may be used if the electrolyte contains a liquid or gel electrolyte. This lithium battery can further contain a cathode current collector in electronic contact with the cathode.

In an embodiment, the lithium battery further contains an anode current collector in electronic contact with the anode. Alternatively and more preferably, in the lithium battery, the graphene foam operates as an anode current collector to collect electrons from the anode active material during a charge of the lithium battery, which contains no separate or additional current collector. The lithium battery can be a lithium-ion battery, lithium metal battery, lithium-sulfur battery, or lithium-air battery.

In a preferred embodiment, the solid graphene foam-protected anode active material is made into a continuous-length roll sheet form (a roll of a continuous foam sheet) having a thickness no greater than 200 μm and a length of at least 1 meter long, preferably at least 2 meters, further preferably at least 10 meters, and most preferably at least 100 meters. This sheet roll is produced by a roll-to-roll process. There has been no prior art graphene foam that is made into a sheet roll form. It has not been previously found or suggested possible to have a roll-to-roll process for producing a continuous length of graphene foam, either pristine or non-pristine.

The presently invented anode layer may be produced by a process comprising:

(a) preparing a graphene dispersion having particles of an anode active material (e.g. a niobium-containing composite metal oxide, such as TiNb₂O₇ and TiNb₂₋ₓTaₓO_{y}) or a precursor to such a composite metal oxide (e.g. a mixture of Ti(OC₃H₇)₄ and Nb(OH)₅ as a precursor to TiNb₂O₇) and a graphene material dispersed in a liquid medium, wherein the graphene material is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein the dispersion contains an optional blowing agent;
(b) dispensing and depositing the graphene dispersion onto a surface of a supporting substrate (e.g. plastic film, rubber sheet, metal foil, glass sheet, paper sheet, etc.) to form a wet layer of graphene-anode material mixture, wherein the dispensing and depositing procedure includes subjecting the graphene dispersion to an orientation-inducing stress;
(c) partially or completely removing the liquid medium from the wet layer of graphene-anode material mixture to form a dried layer of material mixture having a content of non-carbon elements (e.g. O, H, N, B, F, Cl, Br, I, etc.) no less than 5% by weight; and
(d) heat treating the dried layer of material mixture at a first heat treatment temperature from 100° C. to 1,500° C. at a desired heating rate sufficient to induce volatile gas molecules from the non-carbon elements or to activate the blowing agent for producing the anode layer.

Such a heat treatment in step (d) serves to reduce the content of non-carbon elements (e.g. converting graphene oxide or graphene fluoride to graphene). Such a heat treatment also acts to convert the precursor species to the composite metal oxide crystals, which are preferentially nucleated from graphene surfaces. For instance, the mixture of Ti(OC₃H₇)₄ and Nb(OH)₅ is thermally converted to TiNb₂O₇ crystals. The sizes of these crystals can be controlled; typically in such a manner that there are a larger number of smaller composite metal oxide particles that are formed than those produced in the absence of the graphene walls. These smaller active particle sizes mean faster lithium ion diffusion (shorter diffusion paths), thereby enabling faster charges/discharges of the lithium-ion battery containing such an anode.

The solid graphene foam in the anode layer typically has a density from 0.01 to 1.7 g/cm³ (more typically from 0.1 to 1.5 g/cm³, and even more typically from 0.1 to 1.0 g/cm³, and most typically from 0.2 to 0.75 g/cm³), or a specific surface area from 50 to 3,000 m²/g (more typically from 200 to 2,000 m²/g, and most typically from 500 to 1,500 m²/g).

This optional blowing agent is not required if the graphene material has a content of non-carbon elements (e.g. O, H, N, B, F, Cl, Br, I, etc.) no less than 5% by weight (preferably no less than 10%, further preferably no less than 20%, even more preferably no less than 30% or 40%, and most preferably up to 50%). The subsequent high temperature treatment serves to remove a majority of these non-carbon elements from the graphene material, generating volatile gas species that produce pores or cells in the solid graphene material structure. In other words, quite surprisingly, these non-carbon elements play the role of a blowing agent. Hence, an externally added blowing agent is optional (not required). However, the use of a blowing agent can provide added flexibility in regulating or adjusting the porosity level and pore sizes for a desired application. The blowing agent is typically required if the non-carbon element content is less than 5%, such as pristine graphene that is essentially all-carbon.

The blowing agent can be a physical blowing agent, a chemical blowing agent, a mixture thereof, a dissolution-and-leaching agent, or a mechanically introduced blowing agent.

The process may further include a step of heat-treating the anode layer at a second heat treatment temperature higher than the first heat treatment temperature for a length of time sufficient for obtaining an anode layer wherein the pore walls contain stacked graphene planes having an inter-plane spacing d₀₀₂ from 0.3354 nm to 0.40 nm and a content of non-carbon elements less than 5% by weight (typically from 0.001% to 2%). When the resulting non-carbon element content is from 0.1% to 2.0%, the inter-plane spacing d₀₀₂ is typically from 0.337 nm to 0.40 nm.

If the original graphene material in the dispersion contains a fraction of non-carbon elements higher than 5% by weight, the graphene material in the solid graphene foam (after the heat treatment) contains structural defects that are induced during the step (d) of heat treating. The liquid medium can be simply water and/or an alcohol, which is environmentally benign.

In a preferred embodiment, the process is a roll-to-roll process wherein steps (b) and (c) include feeding the supporting substrate from a feeder roller to a deposition zone, continuously or intermittently depositing the graphene dispersion onto a surface of the supporting substrate to form the wet layer thereon, drying the wet layer to form the dried layer of material mixture, and collecting the dried layer of material mixture deposited on the supporting substrate on a collector roller. Such a roll-to-roll or reel-to-reel process is a truly industrial-scale, massive manufacturing process that can be automated.

In one embodiment, the first heat treatment temperature is from 100° C. to 1,500° C. In another embodiment, the second heat treatment temperature includes at least a temperature selected from (A) 1,500-2,100° C. or (B) 2,100-3,200° C. In a specific embodiment, the heat treatments includes a first temperature in the range of 300-1,500° C. for at least 1 hour (typically 1-24 hours and more typically 1-12 hours) and then a second temperature in the range of 1,500-2,500° C. for at least 0.5 hours (typically 1-3 hours).

There are several surprising results of conducting first and/or second heat treatments to the dried graphene-anode active material mixture layer, and different heat treatment temperature ranges enable us to achieve different purposes, such as (a) removal of non-carbon elements from the graphene material (e.g. thermal reduction of fluorinated graphene to obtain graphene or reduced graphene fluoride, RGF)) which generate volatile gases to produce pores or cells in a graphene material, (b) activation of the chemical or physical blowing agent to produce pores or cells, (c) chemical merging or linking of graphene sheets to significantly increase the lateral dimension of graphene sheets in the foam walls (solid portion of the foam), (d) healing of defects created during fluorination, oxidation, or nitrogenation of graphene planes in a graphite particle, (e) re-organization and perfection of graphitic domains or graphite crystals, and (f) conversion of precursor species to the desired niobium-based composite metal oxide particles. These different purposes or functions are achieved to different extents within different temperature ranges. The non-carbon elements typically include an element selected from oxygen, fluorine, chlorine, bromine, iodine, nitrogen, hydrogen, or boron. Quite surprisingly, even under low-temperature foaming conditions, heat-treating induces chemical linking, merging, or chemical bonding between graphene sheets, often in an edge-to-edge manner (some in face-to-face manner).

In one embodiment, the solid graphene foam, minus the anode active material, has a specific surface area from 200 to 2,000 m²/g. In one embodiment, the solid graphene foam has a density from 0.1 to 1.5 g/cm³. In an embodiment, step (d) of heat treating the dried layer of graphene-anode active material mixture at a first heat treatment temperature is conducted under a compressive stress. In another embodiment, the process comprises a compression step to reduce a thickness, pore size, or porosity level of the sheet of graphene foam. In battery cells, the anode layer typically has a thickness from 10 μm to 300 μm, more typically from 50 μm to 200 μm.

In an embodiment, the graphene dispersion has at least 3% by weight of graphene oxide dispersed in the liquid medium to form a liquid crystal phase. In another embodiment, the graphene dispersion contains a graphene oxide dispersion prepared by immersing a graphitic material in a powder or fibrous form in an oxidizing liquid in a reaction vessel at a reaction temperature for a length of time sufficient to obtain the graphene dispersion wherein the graphitic material is selected from natural graphite, artificial graphite, mesophase carbon, mesophase pitch, mesocarbon microbead, soft carbon, hard carbon, coke, carbon fiber, carbon nano-fiber, carbon nano-tube, or a combination thereof and wherein the graphene oxide has an oxygen content no less than 5% by weight.

In an embodiment, the first heat treatment temperature contains a temperature in the range of 80° C.-300° C. and, as a result, the graphene foam has an oxygen content or non-carbon element content less than 5%, and the pore walls have an inter-graphene spacing less than 0.40 nm, a thermal conductivity of at least 150 W/mK (more typically at least 200 W/mk) per unit of specific gravity, and/or an electrical conductivity no less than 2,000 S/cm per unit of specific gravity.

In a preferred embodiment, the first and/or second heat treatment temperature contains a temperature in the range of 300° C.-1,500° C. and, as a result, the graphene foam has an oxygen content or non-carbon content less than 1%, and the pore walls have an inter-graphene spacing less than 0.35 nm, a thermal conductivity of at least 250 W/mK per unit of specific gravity, and/or an electrical conductivity no less than 2,500 S/cm per unit of specific gravity.

When the first and/or second heat treatment temperature contains a temperature in the range of 1,500° C.-2,100° C., the graphene foam has an oxygen content or non-carbon content less than 0.01% and pore walls have an inter-graphene spacing less than 0.34 nm, a thermal conductivity of at least 300 W/mK per unit of specific gravity, and/or an electrical conductivity no less than 3,000 S/cm per unit of specific gravity.

When the first and/or second heat treatment temperature contains a temperature greater than 2,100° C., the graphene foam has an oxygen content or non-carbon content no greater than 0.001% and pore walls have an inter-graphene spacing less than 0.336 nm, a mosaic spread value no greater than 0.7, a thermal conductivity of at least 350 W/mK per unit of specific gravity, and/or an electrical conductivity no less than 3,500 S/cm per unit of specific gravity.

If the first and/or second heat treatment temperature contains a temperature no less than 2,500° C., the graphene foam has pore walls containing stacked graphene planes having an inter-graphene spacing less than 0.336 nm, a mosaic spread value no greater than 0.4, and a thermal conductivity greater than 400 W/mK per unit of specific gravity, and/or an electrical conductivity greater than 4,000 S/cm per unit of specific gravity.

In one embodiment, the pore walls contain stacked graphene planes having an inter-graphene spacing less than 0.337 nm and a mosaic spread value less than 1.0. In another embodiment, the solid wall portion of the graphene foam exhibits a degree of graphitization no less than 80% and/or a mosaic spread value less than 0.4. In yet another embodiment, the solid wall portion of the graphene foam exhibits a degree of graphitization no less than 90% and/or a mosaic spread value no greater than 0.4.

Typically, the pore walls contain a 3D network of interconnected graphene planes that are electron-conducting pathways. The cell walls contain graphitic domains or graphite crystals having a lateral dimension (Lₐ, length or width) no less than 20 nm, more typically and preferably no less than 40 nm, still more typically and preferably no less than 100 nm, still more typically and preferably no less than 500 nm, often greater than 1 μm, and sometimes greater than 10 μm. The graphitic domains typically have a thickness from 1 nm to 200 nm, more typically from 1 nm to 100 nm, further more typically from 1 nm to 40 nm, and most typically from 1 nm to 30 nm.

Preferably, the solid graphene foam contains pores having a pore size from 2 nm to 10 μm (preferably 2 nm to 500 nm and more preferably from 2 nm to 200 nm). It may be noted that it has not been possible to use Ni-catalyzed CVD to produce graphene foams having a pore size range of 2-20 nm. This is due to the notion that it has not been proven possible to prepare Ni foam templates having such a pore size range and not possible for the hydrocarbon gas (precursor molecules) to readily enter Ni foam pores of these sizes. These Ni foam pores must also be interconnected. Additionally, the sacrificial plastic colloidal particle approaches have resulted in macropores that are in the size range of microns to millimeters.

In a preferred embodiment, the present invention provides a roll-to-roll process for producing an anode layer composed of an anode active material and a solid graphene foam, which is composed of multiple pores and pore walls. The process comprises: (a) preparing a graphene dispersion having an anode active material (or its precursor) and a graphene material dispersed in a liquid medium, wherein the dispersion optionally contains a blowing agent; (b) continuously or intermittently dispensing and depositing the graphene dispersion onto a surface of a supporting substrate to form a wet layer of graphene-anode active material mixture, wherein the supporting substrate is a continuous thin film supplied from a feeder roller and collected on a collector roller; (c) partially or completely removing the liquid medium from the wet layer to form a dried layer of material mixture; and (d) heat treating the dried layer of material mixture at a first heat treatment temperature from 100° C. to 1,500° C. at a desired heating rate sufficient to activate the blowing agent for producing said solid graphene foam having a density from 0.01 to 1.7 g/cm³ or a specific surface area from 50 to 3,000 m²/g.

The orientation-inducing stress may be a shear stress. As an example, the shear stress can be encountered in a situation as simple as a “doctor's blade” that guides the spreading of graphene dispersion over a plastic or glass surface during a manual casting process. As another example, an effective orientation-inducing stress is created in an automated roll-to-roll coating process in which a “knife-on-roll” configuration dispenses the graphene dispersion over a moving solid substrate, such as a plastic film. The relative motion between this moving film and the coating knife acts to effect orientation of graphene sheets along the shear stress direction.

This orientation-inducing stress is a critically important step in the production of the presently invented graphene foams due to the surprising observation that the shear stress enables the graphene sheets to align along a particular direction (e.g. X-direction or length-direction) to produce preferred orientations and facilitate contacts between graphene sheets along foam walls. Further surprisingly, these preferred orientations and improved graphene-to-graphene contacts facilitate chemical merging or linking between graphene sheets during the subsequent heat treatment of the dried graphene layer. Such preferred orientations and improved contacts are essential to the eventual attainment of exceptionally high thermal conductivity, electrical conductivity, elastic modulus, and mechanical strength of the resulting graphene foam. In general, these great properties could not be obtained without such a shear stress-induced orientation control.

### BRIEF DESCRIPTION OF THE DRAWINGS

FIG. 1 Schematic of a graphene foam-protected anode active material according to an embodiment of the present invention.

FIG. 2(A) A flow chart illustrating various prior art processes of producing exfoliated graphite products (flexible graphite foils and expanded graphite flakes), along with a process for producing pristine graphene foam 40a or graphene oxide foams 40b;

FIG. 2(B) Schematic drawing illustrating the processes for producing conventional paper, mat, film, and membrane of simply aggregated graphite or NGP flakes/platelets. All processes begin with intercalation and/or oxidation treatment of graphitic materials (e.g. natural graphite particles).

FIG. 3(A) Schematic of a prior art lithium-ion battery cell, wherein the anode layer is a thin coating of an anode active material itself.

FIG. 3(B) Schematic of another lithium-ion battery; the anode layer being composed of particles of an anode active material, a conductive additive (not shown) and a resin binder (not shown).

FIG. 4 A possible mechanism of chemical linking between graphene oxide sheets, which mechanism effectively increases the graphene sheet lateral dimensions.

FIG. 5(A) Thermal conductivity values vs. specific gravity of the GO suspension-derived foam produced by the presently invented process, mesophase pitch-derived graphite foam, and Ni foam-template assisted CVD graphene foam;

FIG. 5(B) Thermal conductivity values of the GO suspension-derived foam, sacrificial plastic bead-templated GO foam, and the hydrothermally reduced GO graphene foam;

FIG. 5(C) electrical conductivity data for the GO suspension-derived foam produced by the presently invented process and the hydrothermally reduced GO graphene foam; and

FIG. 6(A) Thermal conductivity values (vs. specific gravity values up to 1.02 g/cm³) of the GO suspension-derived foam, mesophase pitch-derived graphite foam, and Ni foam-template assisted CVD graphene foam;

FIG. 6(B) Thermal conductivity values of the GO suspension-derived foam, sacrificial plastic bead-templated GO foam, and hydrothermally reduced GO graphene foam (vs. specific gravity values up to 1.02 g/cm³);

FIG. 7 Thermal conductivity values of graphene foam samples derived from GO and GF (graphene fluoride) as a function of the specific gravity.

FIG. 8 Thermal conductivity values of graphene foam samples derived from GO and pristine graphene as a function of the final (maximum) heat treatment temperature.

FIG. 9(A) Inter-graphene plane spacing in graphene foam walls as measured by X-ray diffraction;

FIG. 9(B) The oxygen content in the GO suspension-derived graphene foam.

FIG. 10 The specific capacity of 3 cells: one containing an anode of graphene foam-protected TiNb₂O₇ particles/graphene, a cell containing an anode of carbon-coated TiNb₂O₇ nanocrystals, and a cell containing ball-milled graphite-TiNb₂O₇, each plotted as a function of the number of charge/discharge cycles.

FIG. 11 The specific capacity of 2 cells: a cell containing an anode of graphene foam-protected TiMoNbO₇ particles/graphene and a cell containing non-protected TiMoNbO₇ particles, each plotted as a function of the number of charge/discharge cycles.

FIG. 12 The Ragone plots (power density vs. energy density) of three cells: a cell containing an anode of graphene-protected particles of Fe_{0.1}Ti_{0.8}Nb_{2.1}O₇, a cell containing an anode of carbon-coated Fe_{0.1}Ti_{0.8}Nb_{2.1}O₇, and a cell containing an anode of Li₄Ti₅O₁₂.

### DESCRIPTION OF THE PREFERRED EMBODIMENTS

The term “pristine graphene material” is defined as a graphene material having from zero percent to 0.01% of non-carbon elements. The term “non-pristine graphene material” is defined as a graphene material having 0.01% to about 50% by weight of non-carbon elements. Non-pristine graphene includes graphene oxide, reduced graphene oxide, graphene fluoride, graphene chloride, graphene bromide, graphene iodide, hydrogenated graphene, nitrogenated graphene, boron-doped graphene, nitrogen-doped graphene, chemically functionalized graphene, and combinations thereof. Continuous open porosity is defined as pores accessible to adsorption or desorption of nitrogen during nitrogen BET analysis.

This invention is directed at the anode layer (negative electrode layer) containing a niobium-based composite metal oxide anode material for the lithium secondary battery, which is preferably a secondary battery based on a non-aqueous electrolyte, a polymer gel electrolyte, an ionic liquid electrolyte, a quasi-solid electrolyte, or a solid-state electrolyte. The shape of a lithium secondary battery can be cylindrical, square, button-like, etc. The present invention is not limited to any battery shape or configuration.

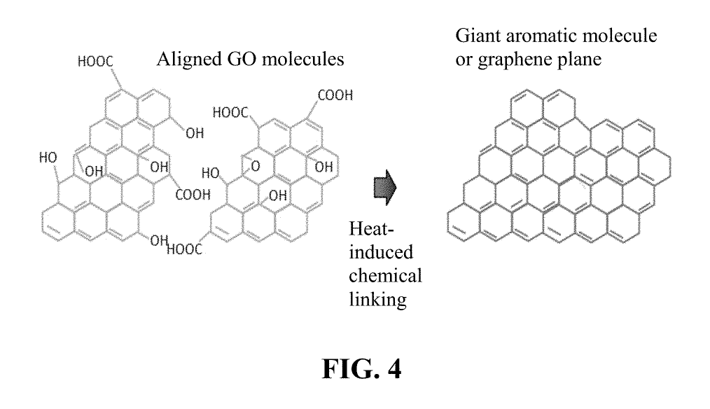

As illustrated in FIG. 4(A) and FIG. 4(B), a lithium-ion battery cell is typically composed of an anode current collector (e.g. Cu foil), an anode or negative electrode (anode layer containing an anode active material, conductive additive, and binder), a porous separator and/or an electrolyte component, a cathode electrode (cathode active material, conductive additive, and resin binder), and a cathode current collector (e.g. Al foil). In a more commonly used cell configuration (FIG. 4(B)), the anode layer is composed of particles of an anode active material (e.g. graphite, Sn, SnO₂, Si, or TiNb₂O₇), a conductive additive (e.g. carbon black particles), and a resin binder (e.g. SBR or PVDF). This anode layer is typically 50-300 μm thick (more typically 100-200 μm) to give rise to a sufficient amount of current per unit electrode area. This thickness range is an industry-accepted constraint under which a battery designer must work. This constraint is due to several reasons: (a) the existing battery electrode coating machines are not equipped to coat excessively thin or excessively thick electrode layers; (b) a thinner layer is preferred based on the consideration of reduced lithium ion diffusion path lengths; but, too thin a layer (e.g. <<100 μm) does not contain a sufficient amount of an active lithium storage material (hence, insufficient current output); and (c) all non-active material layers in a battery cell (e.g. current collectors, conductive additive, binder resin, and separator) must be kept to a minimum in order to obtain a minimum overhead weight and a maximum lithium storage capability and, hence, a maximized energy density (Wk/kg or Wh/L, of cell).

In a less commonly used cell configuration, as illustrated in FIG. 4(A), the anode active material is deposited in a thin film form directly onto an anode current collector, such as a sheet of copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area. Such a thin film must have a thickness less than 100 nm to be more resistant to cycling-induced cracking. Such a constraint further diminishes the total lithium storage capacity and the lithium storage capacity per unit electrode surface area. Such a thin-film battery has very limited scope of application. On the other hand, a Si layer thicker than 100 nm has been found to exhibit poor cracking resistance during battery charge/discharge cycles. It takes but a few cycles to get such a thick film fragmented. A desirable electrode thickness is at least 100 μm. These thin-film electrodes (with a thickness<100 nm) fall short of the required thickness by three (3) orders of magnitude. As a further problem, Si or SiO₂ film-based anode layers cannot be too thick either since these materials are not conductive to both electrons and lithium ions and, thus, a large layer thickness implies an excessively high internal resistance.

In other words, there are several conflicting factors that must be considered concurrently when it comes to the design and selection of an anode active material in terms of material type, shape, size, porosity, and electrode layer thickness. Thus far, there has been no effective solution offered by any prior art teaching to these often conflicting problems. We have solved these challenging issues that have troubled battery designers and electrochemists alike for more than 30 years by developing the graphene foam-protected anode active material.

The present invention provides an anode layer containing (A) a sheet of solid graphene foam composed of multiple pores and pore walls and (B) a niobium-based composite metal oxide anode active material with the particles of this anode active material residing in some of these pores; some pores remaining unoccupied, acting to cushion volume expansion of anode active material particles. The invention also provides a process for producing such an anode layer.

More specifically, the invented anode or negative electrode layer comprises particles of an anode active material (niobium-based composite metal oxide) embedded in pores of a solid graphene foam, which is composed of multiple pores and pore walls (solid portion of the graphene foam), wherein (a) the pore walls contain a pristine graphene material having essentially zero percent of non-carbon elements or a non-pristine graphene material having 0.001% to 5% by weight of non-carbon elements, wherein the non-pristine graphene is selected from graphene oxide, reduced graphene oxide, graphene fluoride, graphene chloride, graphene bromide, graphene iodide, hydrogenated graphene, nitrogenated graphene, boron-doped graphene, nitrogen-doped graphene, chemically functionalized graphene, or a combination thereof; (b) the anode active material is in an amount from 0.5% to 99% by weight (preferably from 2% to 95% by weight and more preferably from 5% to 90% by weight) based on the total weight of the graphene foam and the anode active material combined; and (c) the pores are lodged with the particles of the anode active material. The bonded graphene planes in the foam walls produced by the presently invented process are found to be capable of elastically deforming to the extent that is responsive to the expansion and shrinkage of the anode active material particles.

The solid graphene foam typically has a density from 0.01 to 1.7 g/cm³, (more typically from 0.05 to 1.6 g/cm³, further more typically from 0.1 to 1.5 g/cm³, and more desirably from 0.5 to 0.01 to 1.3 g/cm³), a specific surface area from 50 to 2,000 m²/g, a thermal conductivity of at least 100 W/mK per unit of specific gravity, and/or an electrical conductivity no less than 1,000 S/cm per unit of specific gravity. It may be noted that these ranges of physical densities are not arbitrarily selected ranges. On the one hand, these densities are designed so that the internal pore amount (level of porosity) is sufficiently large to accommodate the maximum amount of an anode active material. On the other hand, the pore amount cannot be too large (or physical density being too low); otherwise, the pore walls of the graphene foam structure cannot be sufficiently elastic (or, not capable of undergoing a large deformation that is fully recoverable or reversible) and strong for electrode fabrication.

Ideally, the pores should expand to the same extent as the embraced anode active material particle does; and should shrink back to the same extent as the anode active material particle. In other words, the graphene foam walls must be fully elastic to meet such a requirement. This is a most challenging task; but, we have surprisingly observed that good elasticity of graphene foam can be achieved with sufficiently long/wide graphene planes (length/width of graphene planes larger than pore diameters) and a sufficient amount (5%-20% of total pore volumes) of small pores (2-100 nm) that are not occupied by an anode active material particle.

The niobium-containing composite metal oxide is selected from the group consisting of TiNb₂O₇, LiₓTiNb₂O₇ (0<x≤5), LiₓM_{(1-y)}Nb_{y}Nb₂O_{(7+δ)}(wherein 0≤x≤6, 0≤y≤1, −1≤δ≤1, and M=Ti or Zr), TiₓNb_{y}O₇ (0.5≤y/x<2.0), TiNbₓO_{(2+5x/2)} (1.9≤x<2.0), MₓTi₍₁₋₂ₓ₎Nb₍₂₊ₓ₎O_{(7+δ)}(wherein 0≤x≤0.2, −0.3≤δ≤0.3, and M=a trivalent metal selected from Fe, Ga, Mo, Ta, V, Al, B, and a mixture thereof), MₓTi₍₂₋₂ₓ₎Nb₍₁₀₊ₓ₎O_{(29+δ)} (wherein 0≤x≤0.4, −0.3≤δ≤0.3, and M=a trivalent metal selected from Fe, Ga, Mo, Al, B, and a mixture thereof), MₓTiNb₂O₇ (x<0.5, and M=B, Na, Mg, Al, Si, S, P, K, Ca, Mo, W, Cr, Mn, Co, Ni, and Fe), TiNb₂₋ₓTaₓO_{y} (0≤x<2, 7≤y≤10), Ti₂Nb₁₀₋ᵥTaᵥO_{w} (0≤v<2, 27≤y≤29), LiₓTi_{(1-y)}M1_{y}Nb_{(2-z)}M2_{z}O_{(7+δ)} (wherein 0≤x≤5, 0≤y≤1, 0≤z≤2, −0.3≤δ≤0.3, M1=Zr, Si, and Sn, and M2=V, Ta, and Bi), P-doped versions thereof, B-doped versions thereof, carbon-coated versions thereof, and combinations thereof. In such a niobium-containing composite metal oxide, niobium oxide typically forms the main framework or backbone structure, along with at least another transition metal oxide.

As an example, the anode active material comprises a monoclinic complex oxide represented by the formula LiₓTi_{(1-y)}M1_{y}Nb_{(2-z)}M2_{z}O_{(7+δ)}(wherein 0≤x≤5, 0≤y≤1, 0≤z≤2, −0.3≤δ≤0.3). In the above formula, M1 is at least one element selected from the group consisting of Zr, Si and Sn and M2 is at least one element selected from the group consisting of V, Ta and Bi. Such a monoclinic complex oxide has a lithium intercalation potential of about 1.5 V (vs. Li⁺/Li) and, thus, enables rapid charge/discharge to be repeated in a stable manner.

Examples of the monoclinic complex oxide represented by the formula LiₓTi_{(1-y)}M1_{y}Nb_{(2-z)}M2_{z}O_{(7+δ)} include monoclinic TiNb₂O₇. In the crystal structure of monoclinic TiNb₂O₇, a metal ion and an oxide ion constitute a skeleton structure. As the metal ion, an Nb ion and a Ti ion are arranged at random in a ratio of Nb:Ti=2:1. The skeleton structures are arranged in 3D alternately and a void exists between the skeleton structures, wherein this void can serve as a host to accommodate lithium ions.

In some portions of the structure, Lithium ion can move in two directions: a [100] direction and a [010] direction. These areas function as a two-dimensional channel for lithium ion. In the crystal structure of monoclinic TiNb₂O₇, a tunnel exists along a [001] direction. The tunnel can serve as the migration path of lithium ions in a [001] direction. The plane index of the crystal typically has symmetry of space group C2/m.

Thus, the crystal structure of the monoclinic complex oxide has a large space which can be inserted by lithium ions without causing structural instability. Furthermore, the crystal structure of the monoclinic complex oxide has two-dimensional channels enabling rapid diffusion of lithium ions and paths connecting these channels along a [001] direction. Thus, the lithium ion can readily get inserted into and released from the insertion spaces in the crystal structure. Further, the effective space to accommodate the lithium ion is sizable in the crystal structure. These features enable the monoclinic complex oxide to deliver a high lithium storage capacity and high rate performance.

Monoclinic complex oxides represented by the formula LiₓTi_{(1-y)}M1_{y}Nb_{(2-z)}M2_{z}O_{(7+δ)} can contain pentavalent cations selected from Nb, V, Ta, and Bi, or tetravalent cations selected from Ti, Zr, Si and Sn.

As another example, the niobium-based composite metal oxide oxide of the present invention may have the formula LiₓM_{(1-y)}Nb_{y}Nb₂O_{(7+δ)}(wherein 0≤x≤6, 0≤y≤1, −1≤δ≤1, and M=Ti or Zr). Examples of such metal oxides include LiₓTiNb₂O₇ (TNO), and LiₓTi_{(1-y})Nb_{y}Nb₂O₇ (TNNO), such as and LiₓTi_{0.9}Nb_{0.1}Nb₂O₇. Partially replacing Ti with Nb enhances the intrinsic conductivity of the niobium mixed oxide composition. For example, replacing 10% Ti atoms at Ti sites with Nb atoms can transform insulating TiNb₂O₇ into conducting Ti₀₉Nb_{0.1}Nb₂O₇.

A niobium-based composite metal oxide of the present invention may be in the form of particles that may be of variable shape, from needles to disks. These particles may be from one to several hundreds of nanometers in any dimension. The particles may aggregated or not, and aggregates may be nearly spherical or ellipsoidal.

The niobium-based composite metal oxide may be prepared in several different ways. For example, a niobium oxide may be prepared by conventional sol-gel methods or by conventional solid state reactions. In particular, TNO and TNNO may be prepared by sol-gel and solid state techniques.

In the sol-gel technique, TNO may be produced using Nb₂O₅, hydrofluoric acid, Ti(OC₃H₇)₄, ammonia, and citric-acid monohydrate as starting materials. First, Nb₂O₅ may be dissolved in hydrofluoric acid to form a transparent solution. In order to remove the F ions from the solution, ammonia may be added to obtain a white Nb(OH)₅ precipitate. After the precipitate is washed and dried, the Nb(OH)₅ may be dissolved in citric acid to form a Nb(V)-citrate solution. A water-ethanol solution containing Ti(OC₃H₇)₄ may be added to this solution while the pH value of the solution is adjusted using ammonia. This final mixture containing Nb(V) and Ti(IV) ions may be stirred at 90° C. to form a citric gel. This gel may then be heated to 140° C. to obtain a precursor. The precursor may be annealed at 900° C. and at 1350° C. to obtain the TNO product.

A TNNO product may be prepared by a solid state reaction, with stoichiometric amounts of the starting materials, Nb₂O₅, Nb, and TiO₂. The starting materials may be thoroughly ground and pressed into pellets. The pellets may be wrapped in Ta foil, sealed in a vacuum quartz tube, and annealed. The size of the oxide particles may be tailored by the annealing temperature and time. For example, annealing may occur by heating at 900° C., then at 1100° C., with each temperature being maintained for 24 hours to obtain particles in the nanometer size range. Oxides containing lithium (wherein x>0) may be obtained electrochemically upon first discharge.

The niobium-containing composite metal oxide may be in the form of carbon-coated metal oxide particles. The carbon coating may be continuous or discontinuous covering all or a portion of the niobium-based composite oxide. In one embodiment, the amount of the carbon coating, if present, may be up to 5.0% by weight of the coated niobium-based composite metal oxide composition. In certain embodiments, the carbon coating may be present in an amount of 0.1% to 3% by weight of the coated niobium-containing composite metal oxide composition. The presence of a carbon coating enhances the electronic conductivity of the niobium oxide and may help stabilize the Nb(IV) valence state.

A carbon coating, if present, can be formed by known methods and one of skill in the art could readily select an appropriate method to form a desirable carbon coating. In one example, one may mix an organic carbon precursor with the niobium oxide and then pyrolyze the mixture at a temperature within the stability temperature range of the niobium. Such pyrolysis may be carried out under a non-oxidizing atmosphere. The carbon-coated primary particles of a niobium-containing composite metal oxide may then be wrapped around by graphene sheets.

The anode active material may further include prelithiated or non-lithiated particles of natural graphite, artificial graphite, or other anode active materials (e.g. Si, SiO, Sn, SnO₂, Ge, and Li₄Ti₅O₁₂, etc.) The particles of the anode active material may be in the form of a nanoparticle, nanowire, nanofiber, nanotube, nanosheet, nanobelt, nanoribbon, or nanocoating. Preferably, the nanoparticle, nanowire, nanofiber, nanotube, nanosheet, nanobelt, nanoribbon, or nanocoating is prelithiated. Preferably, the particles are embraced by an electron-conducting and/or lithium-conducting coating, such as an amorphous carbon produced by chemical vapor deposition (CVD) or pyrolization of a resin.

Briefly, the process for producing the invented anode layer comprises the following steps:

(a) preparing a graphene dispersion having particles of an anode active material (containing niobium-based composite metal oxide or precursor species thereof) and graphene sheets dispersed in a liquid medium, wherein graphene sheets are selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein the dispersion contains an optional blowing agent with a blowing agent-to-graphene material weight ratio from 0/1.0 to 1.0/1.0 (this blowing agent is normally required if the graphene material is pristine graphene, typically having a blowing agent-to-pristine graphene weight ratio from 0.01/1.0 to 1.0/1.0);

(b) dispensing and depositing the graphene dispersion onto a surface of a supporting substrate (e.g. plastic film, rubber sheet, metal foil, glass sheet, paper sheet, etc.) to form a wet layer of graphene-anode material mixture, wherein the dispensing and depositing procedure (e.g. coating or casting) preferably includes subjecting the graphene dispersion to an orientation-inducing stress;

(c) partially or completely removing the liquid medium from the wet layer of graphene material to form a dried layer of material mixture; (The graphene sheets preferably have a content of non-carbon elements (e.g. O, H, N, B, F, Cl, Br, I, etc.) no less than 5% by weight. This non-carbon content, when being removed via heat-induced decomposition, produces volatile gases that act as a foaming agent or blowing agent); and

(d) heat treating the dried layer of material mixture at a first heat treatment temperature from 100° C. to 1,500° C. at a desired heating rate sufficient to generate volatile gas molecules from the non-carbon elements in the graphene material or to activate the blowing agent for producing the solid graphene foam.

The pores in the graphene foam are formed slightly before, during, or after sheets of a graphene material are (1) chemically linked/merged together (edge-to-edge and/or face-to-face) typically at a temperature from 100 to 1,500° C. and/or (2) re-organized into larger graphite crystals or domains (herein referred to as re-graphitization) along the pore walls at a high temperature (typically >2,100° C. and more typically >2,500° C.). It may be noted that the particles of the anode active material may be in the form of small particulate, wire, rod, sheet, platelet, ribbon, tube, etc. with a size of <20 μm (preferably <10 μm, more preferably <5 μm, further preferably <1 μm, still more preferably <300 nm, and most preferably <100 nm). These particles are naturally embraced by graphene-containing pore walls in the foam structure. Hence, where particles are present, there are pores in the graphene foam. However, there are additional pores that are formed due to the evolution of volatile gases (from a blowing agent and/or non-carbon elements, such as —OH, —F, etc.) during the heat treatment of the dried graphene layer. These pores play the role of cushioning the local volume expansion of anode particles, thereby avoiding global expansion of the resulting anode layer. The ability of the pore walls to snap back according to the shrinkage extent of the anode particles comes from the surrounding graphene sheets that are bonded and joint to form larger and stronger graphene planes during heat treatments.

A blowing agent or foaming agent is a substance which is capable of producing a cellular or foamed structure via a foaming process in a variety of materials that undergo hardening or phase transition, such as polymers (plastics and rubbers), glass, and metals. They are typically applied when the material being foamed is in a liquid state. It has not been previously known that a blowing agent can be used to create a foamed material while in a solid state. More significantly, it has not been taught or hinted that an aggregate of sheets of a graphene material can be converted into a graphene foam via a blowing agent. The cellular structure in a matrix is typically created for the purpose of reducing density, increasing thermal resistance and acoustic insulation, while increasing the thickness and relative stiffness of the original polymer.

Blowing agents or related foaming mechanisms to create pores or cells (bubbles) in a matrix for producing a foamed or cellular material, can be classified into the following groups:
(a) Physical blowing agents: e.g. hydrocarbons (e.g. pentane, isopentane, cyclopentane), chlorofluorocarbons (CFCs), hydrochlorofluorocarbons (HCFCs), and liquid CO₂. The bubble/foam-producing process is endothermic, i.e. it needs heat (e.g. from a melt process or the chemical exotherm due to cross-linking), to volatize a liquid blowing agent.
(b) Chemical blowing agents: e.g. isocyanate, azo-, hydrazine and other nitrogen-based materials (for thermoplastic and elastomeric foams), sodium bicarbonate (e.g. baking soda, used in thermoplastic foams). Here gaseous products and other by-products are formed by a chemical reaction, promoted by process or a reacting polymer's exothermic heat. Since the blowing reaction involves forming low molecular weight compounds that act as the blowing gas, additional exothermic heat is also released. Powdered titanium hydride is used as a foaming agent in the production of metal foams, as it decomposes to form titanium and hydrogen gas at elevated temperatures. Zirconium (II) hydride is used for the same purpose. Once formed the low molecular weight compounds will never revert to the original blowing agent(s), i.e. the reaction is irreversible.
(c) Mixed physical/chemical blowing agents: e.g. used to produce flexible polyurethane (PU) foams with very low densities. Both the chemical and physical blowing can be used in tandem to balance each other out with respect to thermal energy released/absorbed; hence, minimizing temperature rise. For instance, isocyanate and water (which react to form CO₂) are used in combination with liquid CO₂ (which boils to give gaseous form) in the production of very low density flexible PU foams for mattresses.
(d) Mechanically injected agents: Mechanically made foams involve methods of introducing bubbles into liquid polymerizable matrices (e.g. an unvulcanized elastomer in the form of a liquid latex). Methods include whisking-in air or other gases or low boiling volatile liquids in low viscosity lattices, or the injection of a gas into an extruder barrel or a die, or into injection molding barrels or nozzles and allowing the shear/mix action of the screw to disperse the gas uniformly to form very fine bubbles or a solution of gas in the melt. When the melt is molded or extruded and the part is at atmospheric pressure, the gas comes out of solution expanding the polymer melt immediately before solidification.
(e) Soluble and leachable agents: Soluble fillers, e.g. solid sodium chloride crystals mixed into a liquid urethane system, which is then shaped into a solid polymer part, the sodium chloride is later washed out by immersing the solid molded part in water for some time, to leave small inter-connected holes in relatively high density polymer products.
(f) We have found that the above five mechanisms can all be used to create pores in the graphene materials while they are in a solid state. Another mechanism of producing pores in a graphene material is through the generation and vaporization of volatile gases by removing those non-carbon elements in a high-temperature environment. This is a unique self-foaming process that has never been previously taught or suggested.

In a preferred embodiment, the graphene material in the dispersion is selected from pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof. The starting graphitic material for producing any one of the above graphene materials may be selected from natural graphite, artificial graphite, mesophase carbon, mesophase pitch, mesocarbon microbead, soft carbon, hard carbon, coke, carbon fiber, carbon nano-fiber, carbon nano-tube, or a combination thereof.

For instance, graphene oxide (GO) may be obtained by immersing powders or filaments of a starting graphitic material (e.g. natural graphite powder) in an oxidizing liquid medium (e.g. a mixture of sulfuric acid, nitric acid, and potassium permanganate) in a reaction vessel at a desired temperature for a period of time (typically from 0.5 to 96 hours, depending upon the nature of the starting material and the type of oxidizing agent used). The resulting graphite oxide particles may then be subjected to thermal exfoliation or ultrasonic wave-induced exfoliation to produce GO sheets.

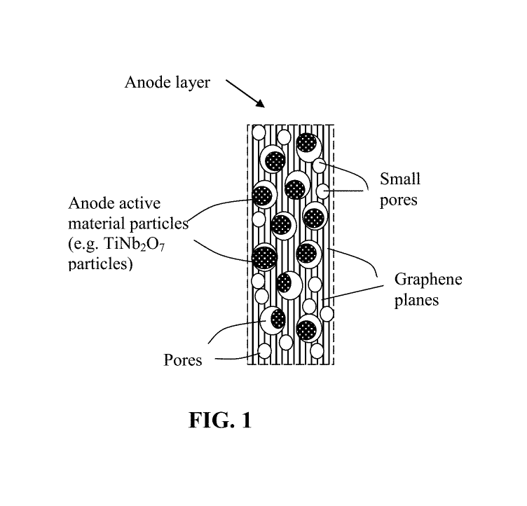

Pristine graphene may be produced by direct ultrasonication (also known as liquid phase production) or supercritical fluid exfoliation of graphite particles. These processes are well-known in the art. Multiple pristine graphene sheets may be dispersed in water or other liquid medium with the assistance of a surfactant to form a suspension. A chemical blowing agent may then be dispersed into the dispersion (38 in FIG. 1(A)). This suspension is then cast or coated onto the surface of a solid substrate (e.g. glass sheet or Al foil). When heated to a desired temperature, the chemical blowing agent is activated or decomposed to generate volatile gases (e.g. N₂ or CO₂), which act to form bubbles or pores in an otherwise mass of solid graphene sheets, forming a pristine graphene foam 40a.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

The pore walls (cell walls or solid graphene portion) in the graphene foam of the presently invented anode layer contain chemically bonded and merged graphene planes. These planar aromatic molecules or graphene planes (hexagonal structured carbon atoms) are well interconnected physically and chemically. The lateral dimensions (length or width) of these planes are huge (e.g. from 20 nm to >10 μm), typically several times or even orders of magnitude larger than the maximum crystallite dimension (or maximum constituent graphene plane dimension) of the starting graphite particles prior to oxidation or intercalation. The graphene sheets or planes are essentially merged and/or interconnected to form electron-conducting pathways with low resistance. The graphene foam may substantially exhibit continuous open porosity, where continuous open porosity is defined as pores accessible to adsorption or desorption of nitrogen during nitrogen BET analysis.

In order to illustrate how the presently invented process works to produce a graphene foam-protected anode layer, we herein make use of graphene oxide (GO) and graphene fluoride (GF) as two examples. These should not be construed as limiting the scope of our claims. In each case, the first step involves preparation of a graphene dispersion (e.g. GO+water or GF+organic solvent, DMF) containing an optional blowing agent. If the graphene material is pristine graphene containing no non-carbon elements, a blowing agent may be required.

In step (b), the GF or GO suspension (21 in FIG. 1(A), but now also containing particles of a desired anode active material) is formed into a wet GF or GO layer 35 on a solid substrate surface (e.g. PET film or glass) preferably under the influence of a shear stress. One example of such a shearing procedure is casting or coating a thin film of GF or GO suspension using a coating machine. This procedure is similar to a layer of varnish, paint, coating, or ink being coated onto a solid substrate. The roller or wiper creates a shear stress when the film is shaped, or when there is a relative motion between the roller/wiper and the supporting substrate. Quite unexpectedly and significantly, such a shearing action enables the planar GF or GO sheets to well align along, for instance, a shearing direction. Further surprisingly, such a molecular alignment state or preferred orientation is not disrupted when the liquid components in the GF or GO suspension are subsequently removed to form a well-packed layer of highly aligned GF or GO sheets that are at least partially dried. The dried GF or GO mass 37a has a high birefringence coefficient between an in-plane direction and the normal-to-plane direction.

In an embodiment, this GF or GO layer, each containing an anode active material therein (comprising niobium-containing composite metal oxide or its precursor species), is then subjected to a heat treatment to activate the blowing agent and/or the thermally-induced reactions that remove the non-carbon elements (e.g. F, 0, etc.) from the graphene sheets to generate volatile gases as by-products. These volatile gases generate pores or bubbles inside the solid graphene material, pushing solid graphene sheets into a foam wall structure, forming a graphene oxide foam 40b. If no blowing agent is added, the non-carbon elements in the graphene material preferably occupy at least 10% by weight of the graphene material (preferably at least 20%, and further preferably at least 30%). The first (initial) heat treatment temperature is typically greater than 80° C., preferably greater than 100° C., more preferably greater than 300° C., further more preferably greater than 500° C. and can be as high as 1,500° C. The blowing agent is typically activated at a temperature from 80° C. to 300° C., but can be higher. The foaming procedure (formation of pores, cells, or bubbles) is typically completed within the temperature range of 80-1,500° C. Quite surprisingly, the chemical linking or merging between graphene planes (GO or GF planes) in an edge-to-edge and face-to-face manner can occur at a relatively low heat treatment temperature (e.g. even as low as from 150° C. to 300° C.).

The foamed graphene material may be subjected to a further heat treatment that involves at least a second temperature that is significantly higher than the first heat treatment temperature.

A properly programmed heat treatment procedure can involve just a single heat treatment temperature (e.g. a first heat treatment temperature only), at least two heat treatment temperatures (first temperature for a period of time and then raised to a second temperature and maintained at this second temperature for another period of time), or any other combination of heat treatment temperatures (HTT) that involve an initial treatment temperature (first temperature) and a final HTT (second), higher than the first. The highest or final HTT that the dried graphene layer experiences may be divided into four distinct HTT regimes:
Regime 1 (80° C. to 300° C.): In this temperature range (the thermal reduction regime and also the activation regime for a blowing agent, if present), a GO or GF layer primarily undergoes thermally-induced reduction reactions, leading to a reduction of oxygen content or fluorine content from typically 20-50% (of O in GO) or 10-25% (of F in GF) to approximately 5-6%. This treatment results in a reduction of inter-graphene spacing in foam walls from approximately 0.6-1.2 nm (as dried) down to approximately 0.4 nm, and an increase in thermal conductivity to 200 W/mK per unit specific gravity and/or electrical conductivity to 2,000 S/cm per unit of specific gravity. (Since one can vary the level of porosity and, hence, specific gravity of a graphene foam material and, given the same graphene material, both the thermal conductivity and electric conductivity values vary with the specific gravity, these property values must be divided by the specific gravity to facilitate a fair comparison.) Even with such a low temperature range, some chemical linking between graphene sheets occurs. The inter-GO or inter-GF planar spacing remains relatively large (0.4 nm or larger). Many O- or F-containing functional groups survive.
Regime 2 (300° C.-1,500° C.): In this chemical linking regime, extensive chemical combination, polymerization, and cross-linking between adjacent GO or GF sheets occur. The oxygen or fluorine content is reduced to typically <1.0% (e.g. 0.7%) after chemical linking, resulting in a reduction of inter-graphene spacing to approximately 0.345 nm. This implies that some initial re-graphitization has already begun at such a low temperature, in stark contrast to conventional graphitizable materials (such as carbonized polyimide film) that typically require a temperature as high as 2,500° C. to initiate graphitization. This is another distinct feature of the presently invented graphene foam and its production processes. These chemical linking reactions result in an increase in thermal conductivity to 250 W/mK per unit of specific gravity, and/or electrical conductivity to 2,500-4,000 S/cm per unit of specific gravity.
Regime 3 (1,500-2,500° C.): In this ordering and re-graphitization regime, extensive graphitization or graphene plane merging occurs, leading to significantly improved degree of structural ordering in the foam walls. As a result, the oxygen or fluorine content is reduced to typically 0.01% and the inter-graphene spacing to approximately 0.337 nm (achieving degree of graphitization from 1% to approximately 80%, depending upon the actual HTT and length of time). The improved degree of ordering is also reflected by an increase in thermal conductivity to >350 W/mK per unit of specific gravity, and/or electrical conductivity to >3,500 S/cm per unit of specific gravity.
Regime 4 (higher than 2,500° C.): In this re-crystallization and perfection regime, extensive movement and elimination of grain boundaries and other defects occur, resulting in the formation of nearly perfect single crystals or poly-crystalline graphene crystals with huge grains in the foam walls, which can be orders of magnitude larger than the original grain sizes of the starting graphite particles for the production of GO or GF. The oxygen or fluorine content is essentially eliminated, typically 0%-0.001%. The inter-graphene spacing is reduced to down to approximately 0.3354 nm (degree of graphitization from 80% to nearly 100%), corresponding to that of a perfect graphite single crystal. The foamed structure thus obtained exhibits a thermal conductivity of >400 W/mK per unit of specific gravity, and electrical conductivity of >4,000 S/cm per unit of specific gravity.

The presently invented graphene foam structure containing an anode active material therein can be obtained by heat-treating the dried GO or GF layer with a temperature program that covers at least the first regime (typically requiring 1-4 hours in this temperature range if the temperature never exceeds 500° C.) and more commonly covers the first two regimes (1-2 hours preferred). If a higher thermal conductivity or electrical conductivity is desired, heat treatments may follow the first three regimes (preferably 0.5-2.0 hours in Regime 3), and can cover all the 4 regimes (including Regime 4 for 0.2 to 1 hour, may be implemented to achieve the highest conductivity).

X-ray diffraction patterns were obtained with an X-ray diffractometer equipped with CuKcv radiation. The shift and broadening of diffraction peaks were calibrated using a silicon powder standard. The degree of graphitization, g, was calculated from the X-ray pattern using the Mering's Eq, d₀₀₂=0.3354 g+0.344 (1−g), where d₀₀₂ is the interlayer spacing of graphite or graphene crystal in nm. This equation is valid only when d₀₀₂ is equal or less than approximately 0.3440 nm. The graphene foam walls having a d₀₀₂ higher than 0.3440 nm reflects the presence of oxygen- or fluorine-containing functional groups (such as —F, —OH, >O, and —COOH on graphene molecular plane surfaces or edges) that act as a spacer to increase the inter-graphene spacing.

Another structural index that can be used to characterize the degree of ordering of the stacked and bonded graphene planes in the foam walls of graphene and conventional graphite crystals is the “mosaic spread,” which is expressed by the full width at half maximum of a rocking curve (X-ray diffraction intensity) of the (002) or (004) reflection. This degree of ordering characterizes the graphite or graphene crystal size (or grain size), amounts of grain boundaries and other defects, and the degree of preferred grain orientation. A nearly perfect single crystal of graphite is characterized by having a mosaic spread value of 0.2-0.4. Most of our graphene walls have a mosaic spread value in this range of 0.2-0.4 (if produced with a heat treatment temperature (HTT) no less than 2,500° C.). However, some values are in the range of 0.4-0.7 if the HTT is between 1,500 and 2,500° C., and in the range of 0.7-1.0 if the HTT is between 300 and 1,500° C.

Illustrated in FIG. 4 is a plausible chemical linking mechanism where only 2 aligned GO molecules are shown as an example, although a large number of GO molecules can be chemically linked together to form a foam wall. Further, chemical linking could also occur face-to-face, not just edge-to-edge for GO, GF, and chemically functionalized graphene sheets. These linking and merging reactions proceed in such a manner that the molecules are chemically merged, linked, and integrated into one single entity. The graphene sheets (GO or GF sheets) completely lose their own original identity and they no longer are discrete sheets/platelets/flakes. The resulting product is not a simple aggregate of individual graphene sheets, but a single entity that is essentially a network of interconnected giant molecules with an essentially infinite molecular weight. This may also be described as a graphene poly-crystal (with several grains, but typically no discernible, well-defined grain boundaries). All the constituent graphene planes are very large in lateral dimensions (length and width) and, if the HTT is sufficiently high (e.g. >1,500° C. or much higher), these graphene planes are essentially bonded together with one another. The graphene foam of the presently invented anode layer has the following unique and novel features that have never been previously taught or hinted:
(1) In-depth studies using a combination of SEM, TEM, selected area diffraction, X-ray diffraction, AFM, Raman spectroscopy, and FTIR indicate that the graphene foam walls are composed of several huge graphene planes (with length/width typically >>20 nm, more typically >>100 nm, often >>1 μm, and, in many cases, >>10 μm, or even >>100 μm). These giant graphene planes are stacked and bonded along the thickness direction (crystallographic c-axis direction) often through not just the van der Waals forces (as in conventional graphite crystallites), but also covalent bonds, if the final heat treatment temperature is lower than 2,500° C. In these cases, wishing not to be limited by theory, but Raman and FTIR spectroscopy studies appear to indicate the co-existence of sp² (dominating) and sp³ (weak but existing) electronic configurations, not just the conventional sp² in graphite.
(2) This graphene foam wall is not made by gluing or bonding discrete flakes/platelets together with a resin binder, linker, or adhesive. Instead, GO sheets (molecules) from the GO dispersion or the GF sheets from the GF dispersion are merged through joining or forming of covalent bonds with one another, into an integrated graphene entity, without using any externally added linker or binder molecules or polymers. For a lithium battery featuring such an anode layer, there is no need to have non-active materials, such as a resin binder or a conductive additive, which are incapable of storing lithium. This implies a reduced amount of non-active materials or increased amount of active materials in the anode, effectively increasing the specific capacity per total anode weight, mAh/g (of composite).
(3) The graphene foam walls are typically a poly-crystal composed of large grains having incomplete grain boundaries. This entity is derived from a GO or GF suspension, which is in turn obtained from natural graphite or artificial graphite particles originally having multiple graphite crystallites. Prior to being chemically oxidized or fluorinated, these starting graphite crystallites have an initial length (Lₐ in the crystallographic a-axis direction), initial width (L_{b} in the b-axis direction), and thickness (L_{c} in the c-axis direction). Upon oxidation or fluorination, these initially discrete graphite particles are chemically transformed into highly aromatic graphene oxide or graphene fluoride molecules having a significant concentration of edge- or surface-borne functional groups (e.g. —F, —OH, —COOH, etc.). These aromatic GO or GF molecules in the suspension have lost their original identity of being part of a graphite particle or flake. Upon removal of the liquid component from the suspension, the resulting GO or GF molecules form an essentially amorphous structure. Upon heat treatments, these GO or GF molecules are chemically merged and linked into a unitary or monolithic graphene entity that constitutes the foam wall. This foam wall is highly ordered.
   The resulting unitary graphene entity in the foam wall typically has a length or width significantly greater than the Lₐ and L_{b} of the original crystallites. The length/width of this graphene foam wall entity is significantly greater than the Lₐ and L_{b} of the original crystallites. Even the individual grains in a poly-crystalline graphene wall structure have a length or width significantly greater than the Lₐ and L_{b} of the original crystallites.
(4) The large length and width of the graphene planes enable the foam walls to be of high mechanical strength and elasticity. In comparative experiments, we observe that without this feature (i.e. no chemical merging of graphene planes), conventionally made graphene foams composed of aggregates of discrete graphene sheets, are very weak, fragile, and non-elastic (deformation not reversible); foam walls being easily collapsed or broken.
(5) Due to these unique chemical composition (including oxygen or fluorine content), morphology, crystal structure (including inter-graphene spacing), and structural features (e.g. high degree of orientations, few defects, incomplete grain boundaries, chemical bonding and no gap between graphene sheets, and substantially no interruptions in graphene planes), the GO- or GF-derived graphene foam has a unique combination of outstanding thermal conductivity, electrical conductivity, mechanical strength, and stiffness (elastic modulus).

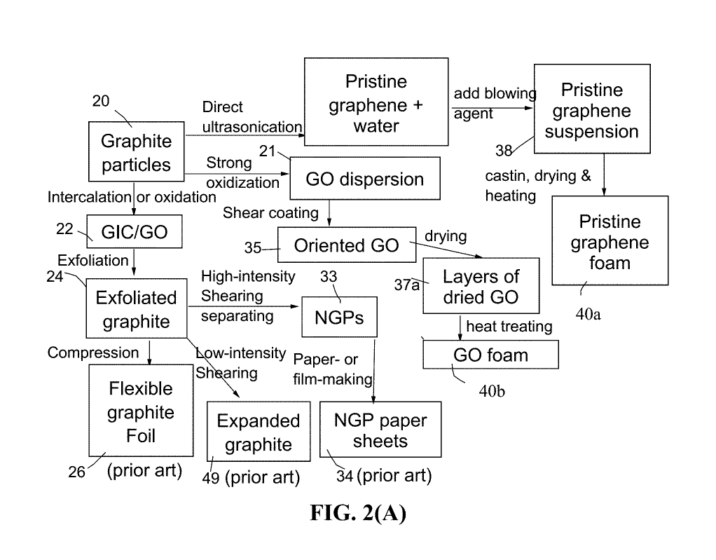

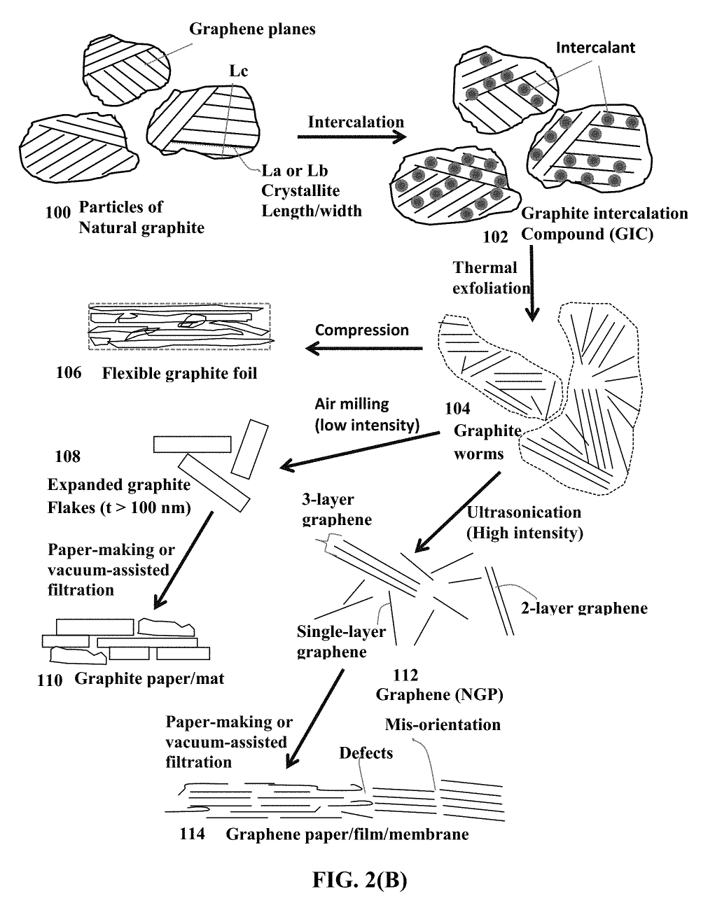

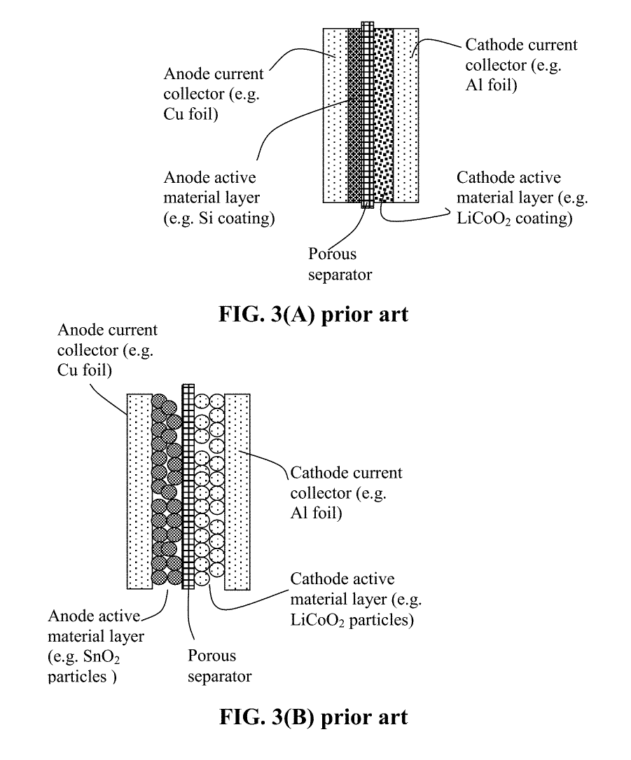

The aforementioned features are further described and explained in detail as follows: As illustrated in FIG. 2(B), a graphite particle (e.g. 100) is typically composed of multiple graphite crystallites or grains. A graphite crystallite is made up of layer planes of hexagonal networks of carbon atoms. These layer planes of hexagonally arranged carbon atoms are substantially flat and are oriented or ordered so as to be substantially parallel and equidistant to one another in a particular crystallite. These layers of hexagonal-structured carbon atoms, commonly referred to as graphene layers or basal planes, are weakly bonded together in their thickness direction (crystallographic c-axis direction) by weak van der Waals forces and groups of these graphene layers are arranged in crystallites. The graphite crystallite structure is usually characterized in terms of two axes or directions: the c-axis direction and the a-axis (or b-axis) direction. The c-axis is the direction perpendicular to the basal planes. The a- or b-axes are the directions parallel to the basal planes (perpendicular to the c-axis direction).

A highly ordered graphite particle can consist of crystallites of a considerable size, having a length of Lₐ along the crystallographic a-axis direction, a width of L_{b} along the crystallographic b-axis direction, and a thickness L_{c} along the crystallographic c-axis direction. The constituent graphene planes of a crystallite are highly aligned or oriented with respect to each other and, hence, these anisotropic structures give rise to many properties that are highly directional. For instance, the thermal and electrical conductivity of a crystallite are of great magnitude along the plane directions (a- or b-axis directions), but relatively low in the perpendicular direction (c-axis). As illustrated in the upper-left portion of FIG. 2(B), different crystallites in a graphite particle are typically oriented in different directions and, hence, a particular property of a multi-crystallite graphite particle is the directional average value of all the constituent crystallites.

Due to the weak van der Waals forces holding the parallel graphene layers, natural graphite can be treated so that the spacing between the graphene layers can be appreciably opened up so as to provide a marked expansion in the c-axis direction, and thus form an expanded graphite structure in which the laminar character of the carbon layers is substantially retained. The process for manufacturing flexible graphite is well-known in the art. In general, flakes of natural graphite (e.g. 100 in FIG. 2(B)) are intercalated in an acid solution to produce graphite intercalation compounds (GICs, 102). The GICs are washed, dried, and then exfoliated by exposure to a high temperature for a short period of time. This causes the flakes to expand or exfoliate in the c-axis direction of the graphite up to 80-300 times of their original dimensions. The exfoliated graphite flakes are vermiform in appearance and, hence, are commonly referred to as worms 104. These worms of graphite flakes which have been greatly expanded can be formed without the use of a binder into cohesive or integrated sheets of expanded graphite, e.g. webs, papers, strips, tapes, foils, mats or the like (typically referred to as “flexible graphite” 106) having a typical density of about 0.04-2.0 g/cm³ for most applications.

The upper left portion of FIG. 2(A) shows a flow chart that illustrates the prior art processes used to fabricate flexible graphite foils. The processes typically begin with intercalating graphite particles 20 (e.g., natural graphite or synthetic graphite) with an intercalant (typically a strong acid or acid mixture) to obtain a graphite intercalation compound 22 (GIC). After rinsing in water to remove excess acid, the GIC becomes “expandable graphite.” The GIC or expandable graphite is then exposed to a high temperature environment (e.g., in a tube furnace preset at a temperature in the range of 800-1,050° C.) for a short duration of time (typically from 15 seconds to 2 minutes). This thermal treatment allows the graphite to expand in its c-axis direction by a factor of 30 to several hundreds to obtain a worm-like vermicular structure 24 (graphite worm), which contains exfoliated, but un-separated graphite flakes with large pores interposed between these interconnected flakes.

In one prior art process, the exfoliated graphite (or mass of graphite worms) is re-compressed by using a calendaring or roll-pressing technique to obtain flexible graphite foils (26 in FIG. 2(A) or 106 in FIG. 2(B)), which are typically 100-300 μm thick. In another prior art process, the exfoliated graphite worm 24 may be impregnated with a resin and then compressed and cured to form a flexible graphite composite, which is normally of low strength as well. In addition, upon resin impregnation, the electrical and thermal conductivity of the graphite worms could be reduced by two orders of magnitude.

Alternatively, the exfoliated graphite may be subjected to high-intensity mechanical shearing/separation treatments using a high-intensity air jet mill, high-intensity ball mill, or ultrasonic device to produce separated nano graphene platelets 33 (NGPs) with all the graphene platelets thinner than 100 nm, mostly thinner than 10 nm, and, in many cases, being single-layer graphene (also illustrated as 112 in FIG. 2(B)). An NGP is composed of a graphene sheet or a plurality of graphene sheets with each sheet being a two-dimensional, hexagonal structure of carbon atoms. A mass of multiple NGPs (including discrete sheets/platelets of single-layer and/or few-layer graphene or graphene oxide, 33 in FIG. 2(A)) may be made into a graphene film/paper (34 in FIG. 2(A) or 114 in FIG. 2(B)) using a film- or paper-making process.

Further alternatively, with a low-intensity shearing, graphite worms tend to be separated into the so-called expanded graphite flakes (108 in FIG. 2(B) having a thickness>100 nm. These flakes can be formed into graphite paper or mat 106 using a paper- or mat-making process. This expanded graphite paper or mat 106 is just a simple aggregate or stack of discrete flakes having defects, interruptions, and misorientations between these discrete flakes.

The present invention also provides a lithium-ion battery comprising the aforementioned anode layer of graphene foam-protected Nb-based composite metal oxide, a cathode, an electrolyte in physical contact with both the anode and the cathode, and an optional separator disposed between the anode and the cathode.

There is no limitation on the type of cathode active materials that can be used to pair up with the presently invented anode active materials. There is also no limitation on what type of electrolyte and separator that can be used. The electrolyte can be an organic, ionic liquid, polymer gel, solid polymer, quasi-solid, solid state electrolyte, or a combination thereof. The separator can be porous polymer membrane, fibril-based membrane, ceramic-coated membrane, etc.

The cathode active material layer may contain a cathode active material selected from an inorganic material, an organic material, a polymeric material, or a combination thereof. The inorganic material may be selected from a metal oxide, metal phosphate, metal silicide, metal selenide, transition metal sulfide, or a combination thereof.

The inorganic material may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, lithium metal silicide, or a combination thereof.

In certain preferred embodiments, the inorganic material as a cathode active material is selected from a metal fluoride or metal chloride including the group consisting of CoF₃, MnF₃, FeF₃, VF₃, VOF₃, TiF₃, BiF₃, NiF₂, FeF₂, CuF₂, CuF, SnF₂, AgF, CuCl₂, FeCl₃, MnCl₂, and combinations thereof. In certain preferred embodiments, the inorganic material is selected from a lithium transition metal silicate, denoted as Li₂MSiO₄ or Li₂MaₓMb_{y}SiO₄, wherein M and Ma are selected from Fe, Mn, Co, Ni, V, or VO; Mb is selected from Fe, Mn, Co, Ni, V, Ti, Al, B, Sn, or Bi; and x+y≤1.

In certain preferred embodiments, the inorganic material is selected from a transition metal dichalcogenide, a transition metal trichalcogenide, or a combination thereof. The inorganic material is selected from TiS₂, TaS₂, MoS₂, NbSe₃, MnO₂, CoO₂, an iron oxide, a vanadium oxide, or a combination thereof.

The cathode active material layer may contain a metal oxide containing vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

The cathode active material layer may contain a metal oxide or metal phosphate, selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In some embodiments, the inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The following examples serve to provide the best modes of practice for the present invention and should not be construed as limiting the scope of the invention.

### Example 1: Sol-Gel Process for Producing Graphene Foam-Protected LiₓTiNb₂O₇ (TNO)

The graphene walls in a graphene foam structure can function as heterogeneous nucleation sites for promoting the formation of niobium-based composite metal oxide crystals. The method of producing graphene-nucleated nanocrystals involves precipitating the precursor to niobium-based composite metal oxide nanoparticles from a solution reactant mixture of Nb(OH)₅ (dissolved in citric acid) and water-ethanol solution containing Ti(OC₃H₇)₄, in the presence of GO sheets.

In an experiment, Nb₂O₅ was dissolved in hydrofluoric acid to form a transparent solution. In order to remove the F ions from the solution, ammonia was added to obtain a white Nb(OH)₅ precipitate. After the precipitate was washed and dried, the Nb(OH)₅ was dissolved in citric acid to form a Nb(V)-citrate solution. A water-ethanol solution containing Ti(OC₃H₇)₄ was added to this solution while the pH value of the solution was adjusted using ammonia. This final mixture containing Nb(V) and Ti(IV) ions was then stirred at 90° C. to form a citric gel. This gel was then added to a GO gel (GO molecules dissolved in water) to form a suspension, which was cast onto a glass plate using a drawdown bar. The cast film was heated to 140° C. to obtain a precursor bonded to graphene pore wall surfaces. The film was annealed at 900° C. for 2 hours and at 1350° C. for 10 hours to obtain the LiₓTiNb₂O₇ (TNO) products nucleated from graphene wall surfaces and residing in pores of the resulting graphene foam.

The amount of GO was designed in such a manner that the final graphene proportion in the graphene foam-protected TNO hybrid was typically from 0.01% to 30%, but more typically from 0.1% to 10% by weight.

### Example 2: Graphene Foam-Protected TiNb₂O₇

In one set of experiments, fine particles of precursor species (TiO₂+Nb₂O₅) to composite metal oxide were added to a graphene oxide-water suspension, which was then slot die-coated and to produce oriented precursor films of TiO₂—Nb₂O₅/GO. These films were then dried and heat-treated to produce an anode layer of graphene foam-protected TiNb₂O₇. As comparative examples, primary particles of TiNb₂O₇ without graphene protection were also prepared.

Titanium dioxide (TiO₂) having an anatase structure and niobium pentoxide (Nb₂O₅) were mixed (with or without dispersion of GO sheets in water), and the mixture was sintered at 1100° C. for 24 hours to obtain a niobium composite oxide having a composition formula TiNb₂O₇ (sample Al and Al-G; the latter having graphene foam protection).

Then, 100 g of the sample Al, 3 g of maltose, 5 g of GO, and 100 g of pure water were put into a beaker, and mixed. The mixture was dispersed with a stirrer using a rotor, and then cast onto a glass plate surface to obtain a film. In this film, presumably primary particles of organic material-coated TiNb₂O₇ are disposed among graphene sheets. Then, sintering (carbonization heat treatment) was carried out in an inert atmosphere in an argon air current at 700° C. for 1 hour to thereby carbonize the organic material to obtain sample Dl-G containing carbon-coated TiNb₂O₇ protected by graphene foam. The corresponding TiNb₂O₇ particles without graphene foam protection are designated as sample Dl. Separately, some amount of sample D1-G was sintered in an inert atmosphere in an argon air flow at 900° C. for 3 hours to obtain a sample E1-G. The TiNb₂O₇ particles without graphene foam protection are designated as sample E1.

The details about preparation and testing of battery cells featuring these anode active materials are presented in Example 11. Some testing results are summarized in Table 1 below, which indicates that the approach of forming graphene foam-protected composite metal oxide particles has enabled the lithium battery to exhibit dramatically better cycle behavior. For a battery suffering just a 0.1% capacity reduction after 100 charge/discharge cycles (e.g. sample Dl-G), the battery quite possible can last for 10,000 cycles (maintaining 80% of its initial capacity). This is unprecedented for lithium-ion batteries which typically last for <2,000 cycles and more typically <1,000 cycles.

TABLE 1
Properties of graphene foam-protected and
un-protected TiNb₂O₇ as an anode.

| | | | Primary | | |
|---|---|---|---|---|---|
| | | | particle | Initial | Capacity |
| | C coating | Graphene | diameter | capacity | retention ratio |
| Sample | % | % | (μm) | (mAh/g) | after 100 cycles |
| A1 | 0 | 0 | 12 | 166 | 34% |
| A1-G | 0 | 2.5 | 0.45 | 224 | 92% |
| D1 | 1.1 | 0 | 0.6 | 280 | 55% |
| D1-G | 1.1 | 2.4 | 0.085 | 295 | 99.9% |
| E1 | 1.2 | 0 | 0.6 | 254 | 40% |
| E1-G | 1.2 | 2.5 | 0.1 | 266 | 99.0% |

### Example 3: Graphene Foam-Protected TiNb₂O₇, TiMoNbO₇, and TiFe_{0.3}Nb_{1.7}O₇

A niobium-titanium composite oxide represented by the general formula TiNb₂O₇ was again synthesized, but using a different approach. Commercially available niobium oxide (Nb₂O₅) and a titanate proton compound were used as starting materials. The titanate proton compound was prepared by immersing potassium titanate in hydrochloric acid at 25° C. for 72 hours. In the process, 1M hydrochloric acid was replaced with a 1M of fresh acid every 24 hours. As a result, potassium ions were exchanged for protons to obtain the titanate proton compound.

The niobium oxide (Nb₂O₅) and the titanate proton compound were weighed such that the molar ratio of niobium to titanium in the synthesized compound was 3. The mixture was dispersed in 100 ml of pure water, followed by vigorous mixing. The obtained mixture was placed in a heat resistant container, and was subjected to hydrothermal synthesis under conditions of 180° C. for a total of 24 hours. The obtained sample was washed in pure water three times, and then dried. The sample was then subjected to a heat treatment at 1,100° C. for 24 hours to obtain TiNb₂O₇.

Additionally, a niobium-molybdenum-titanium composite oxide was synthesized in the same manner as above except that niobium oxide (Nb₂O₅), molybdenum oxide (Mo₂O₅), and a titanate proton compound were weighed such that the molar ratio of niobium to titanium and that of molybdenum to titanium in the synthesized compound was 1.5 and 1.5, respectively. As a result, a niobium-molybdenum-titanium composite oxide (TiMoNbO₇) was obtained.

In addition, a niobium-iron-titanium composite oxide was synthesized in the same manner as above except that niobium oxide (Nb₂O₅), a titanate proton compound, and iron oxide (Fe₂O₃) were weighed such that the molar ratio of niobium to titanium and of iron to titanium in the synthesized compound was 3 and 0.3, respectively. As a result, a niobium-titanium composite oxide (TiFe_{0.3}Nb_{1.7}O₇) was obtained.

The above niobium-containing composite metal oxide powders (TiNb₂O₇, TiMoNbO₇, and TiFe_{0.3}Nb_{1.7}O₇) were separately added into a dispersion containing pristine graphene sheets, a dispersion agent, and water (obtained in Example 8 below) to form a suspension. The suspensions were cast to form films, which were then heat-treated at 1,500° C. for 2 hours to produce graphene foam-protected anode layers.

### Example 4: Graphene Foam-Protected Ga_{0.1}Ti_{0.8}Nb_{2.1}O₇

In an experiment, 0.125 g of GaCl₃ and 4.025 g of NbCl₅ were dissolved in 10 mL of anhydrous ethanol under an inert atmosphere (argon) and magnetic stirring. The solution was transferred under air. Then, added to this solution was 6.052 g solution of titanium oxysulfate (TiOSO₄) at 15% by mass in sulfuric acid, followed by 10 mL of ethanol to dissolve the precursors under a magnetic stirring. The pH of the solution was adjusted to 10 by slow addition of ammonia NH₃ at 28% by mass into water.

The paste was transferred into a Teflon container having a 90-mL capacity, which was then placed in an autoclave. The paste was then heated up to 220° C. for 5 hours with a heating and cooling ramp of 2 and 5 degree C./min, respectively. The paste was then washed with distilled water by centrifugation until a pH between 6 and 7 was obtained. The resulting compound was heated at 60° C. for 12 hours and then ball-milled for 30 min at 500 rpm (revolutions per minute) in hexane. After evaporation of the solvent, the powder was calcinated at 950° C. for 1 hour with a heating/cooling ramp of 3 degree C./min to produce crystals of Ga_{0.1}Ti_{0.8}Nb_{2.1}O₇. On a separate basis, anode layers of graphene foam-protected composite metal oxide particles were also prepared according to a procedure similar to that of Example 3.

### Example 5: Graphene Foam-Protected Fe_{0.1}Ti_{0.8}Nb_{2.1}O₇

In a representative procedure, 0.116 g of FeCl₃ and 4.025 g of NbCl₅ were dissolved in 10 mL of anhydrous ethanol under an inert atmosphere (argon) and magnetic stirring. The resulting solution was transferred under air. Then, added to this solution was 6.052 g of titanium oxysulfate (TiOSO₄) at 15% by mass in sulfuric acid and 10 mL of ethanol to dissolve the precursors under a magnetic stirring. The pH of the solution was adjusted to 10 by slow addition of ammonia NH₃ at 28% by mass into water.

The paste was transferred into a Teflon container having a 90-mL capacity, which was then placed in an autoclave. The paste was then heated up to 220° C. for 5 hours with a heating and cooling ramp of 2 and 5 degree C./min, respectively. The paste was then washed with distilled water by centrifugation until a pH between 6 and 7 was obtained. The compound was heated at 60° C. for 12 hours and then ball-milled for 30 min at 500 rpm in hexane. After evaporation of hexane, the powder was calcinated at 950° C. for 1 hour with a heating/cooling ramp of 3 degree C./min to obtain Fe_{0.1}Ti_{0.8}Nb_{2.1}O₇ crystals. These crystals were further processed in a dispersion containing nitrogenated graphene sheets dispersed in water (prepared in Example 12 below) for production of nitrogenated graphene foam-protected composite metal oxide particulates.

### Example 6: Preparation of Discrete Nano Graphene Platelets (NGPs) which are GO Sheets

Chopped graphite fibers with an average diameter of 12 μm and natural graphite particles were separately used as a starting material, which was immersed in a mixture of concentrated sulfuric acid, nitric acid, and potassium permanganate (as the chemical intercalate and oxidizer) to prepare graphite intercalation compounds (GICs). The starting material was first dried in a vacuum oven for 24 h at 80° C. Then, a mixture of concentrated sulfuric acid, fuming nitric acid, and potassium permanganate (at a weight ratio of 4:1:0.05) was slowly added, under appropriate cooling and stirring, to a three-neck flask containing fiber segments. After 10 hours of reaction, the acid-treated graphite fibers or natural graphite particles were filtered and washed thoroughly with deionized water until the pH level of the solution reached 6. After being dried at 100° C. overnight, the resulting graphite intercalation compound (GIC) or graphite oxide fiber was re-dispersed in water and/or alcohol to form a slurry.

In one sample, five grams of the graphite oxide fibers were mixed with 2,000 ml alcohol solution consisting of alcohol and distilled water with a ratio of 15:85 to obtain a slurry mass. Then, the mixture slurry was subjected to ultrasonic irradiation with a power of 200 W for various lengths of time. After 20 minutes of sonication, GO fibers were effectively exfoliated and separated into thin graphene oxide sheets with oxygen content of approximately 23%-31% by weight. The resulting suspension contains GO sheets being suspended in water. A chemical blowing agent (hydrazo dicarbonamide) was added to the suspension just prior to casting.

The resulting suspension was then cast onto a glass surface using a doctor's blade to exert shear stresses, inducing GO sheet orientations. The resulting GO coating films, after removal of liquid, have a thickness that can be varied from approximately 5 μm to 500 μm (preferably and typically from 10 μm to 50 μm).

For making a graphene foam specimen, the GO coating film was then subjected to heat treatments that typically involve an initial thermal reduction temperature of 80-350° C. for 1-8 hours, followed by heat-treating at a second temperature of 1,500-2,850° C. for 0.5 to 5 hours. It may be noted that we have found it essential to apply a compressive stress to the coating film sample while being subjected to the first heat treatment. This compress stress seems to have helped maintain good contacts between the graphene sheets so that chemical merging and linking between graphene sheets can occur while pores are being formed. Without such a compressive stress, the heat-treated film is typically excessively porous with constituent graphene sheets in the pore walls being very poorly oriented and incapable of chemical merging and linking with one another. As a result, the thermal conductivity, electrical conductivity, and mechanical strength of the graphene foam are severely compromised.

### Example 7: Preparation of Single-Layer Graphene Sheets from Mesocarbon Microbeads (MCMBs)

Mesocarbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours.

The GO sheets contain oxygen proportion of approximately 35%-47% by weight for oxidation treatment times of 48-96 hours. GO sheets were suspended in water. Baking soda (5-20% by weight), as a chemical blowing agent, was added to the suspension just prior to casting. The suspension was then cast onto a glass surface using a doctor's blade to exert shear stresses, inducing GO sheet orientations. Several samples were cast, some containing a blowing agent and some not. The resulting GO films, after removal of liquid, have a thickness that can be varied from approximately 10 to 500 μm.

Then, several sheets of the GO film, with or without a blowing agent, were then subjected to heat treatments that include an initial (first) thermal reduction temperature of 80-500° C. for 1-5 hours. This first heat treatment generated a graphene foam. However, the graphene domains in the foam wall can be further perfected (re-graphitized to become more ordered or having a higher degree of crystallinity and larger lateral dimensions of graphene planes, longer than the original graphene sheet dimensions due to chemical merging) if the foam is followed by heat-treating at a second temperature of 1,500-2,850° C.

### Example 8: Preparation of Pristine Graphene Foam (0% Oxygen)

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to a graphene foam having a higher thermal conductivity. Pristine graphene sheets were produced by using the direct ultrasonication or liquid-phase production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are no other non-carbon elements.

Various amounts (1%-30% by weight relative to graphene material) of chemical bowing agents (N, N-Dinitroso pentamethylene tetramine or 4. 4′-Oxybis (benzenesulfonyl hydrazide) were added to a suspension containing pristine graphene sheets and a surfactant. The suspension was then cast onto a glass surface using a doctor's blade to exert shear stresses, inducing graphene sheet orientations. Several samples were cast, including one that was made using CO₂ as a physical blowing agent introduced into the suspension just prior to casting). The resulting graphene films, after removal of liquid, have a thickness that can be varied from approximately 10 to 100 μm.

The graphene films were then subjected to heat treatments that involve an initial (first) thermal reduction temperature of 80-1,500° C. for 1-5 hours. This first heat treatment led to the production of a graphene foam. Some of the pristine foam samples were then subjected to a second temperature of 1,500-2,850° C. to determine if the graphene domains in the foam wall could be further perfected (re-graphitized to become more ordered or having a higher degree of crystallinity).

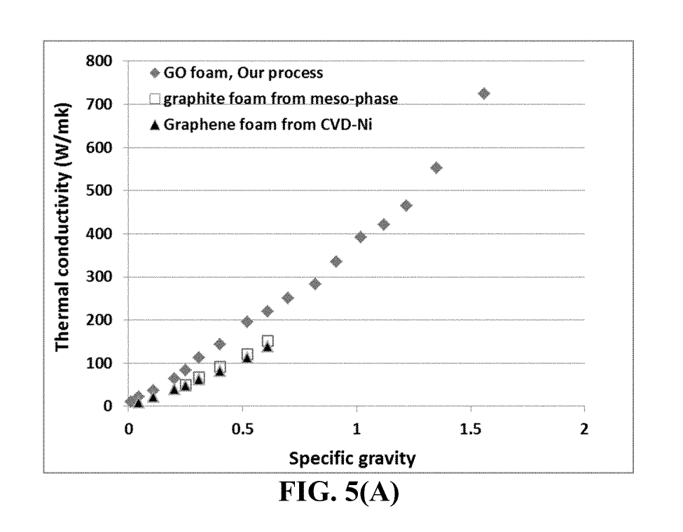

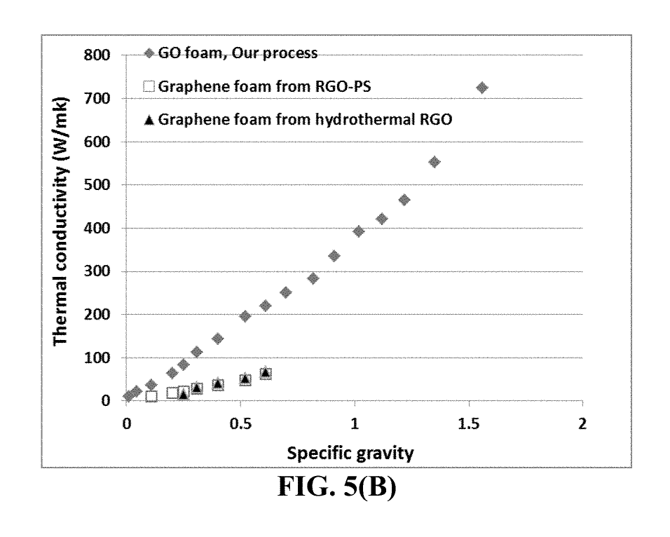

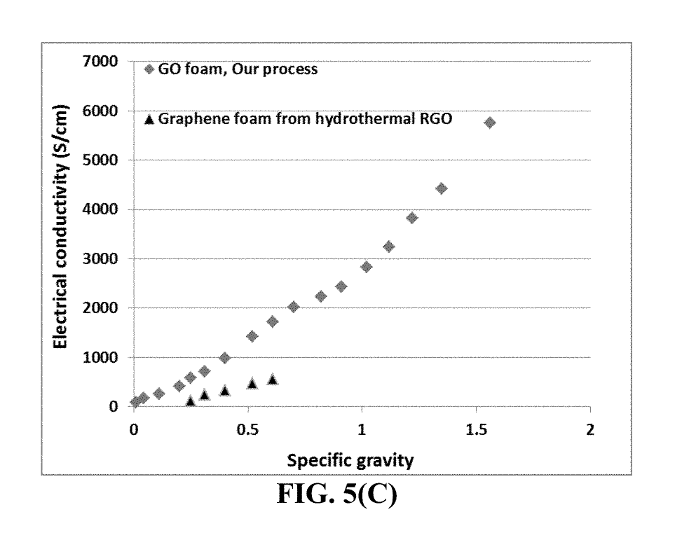

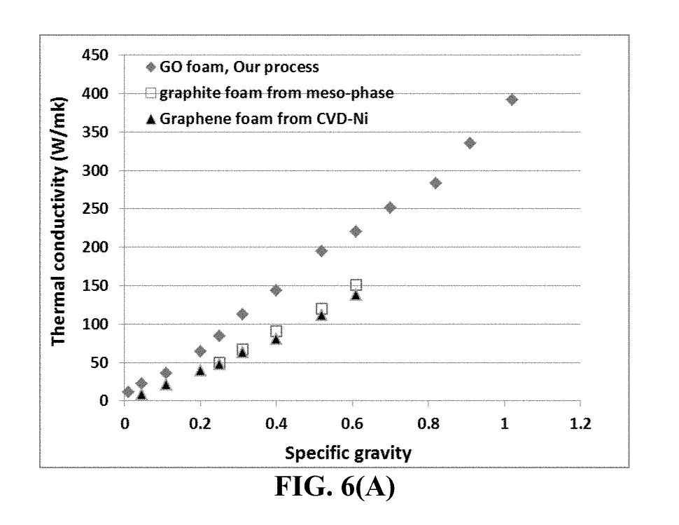

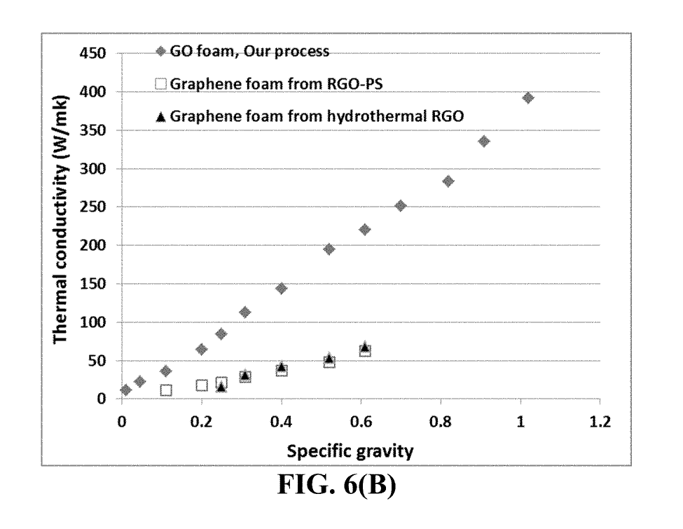

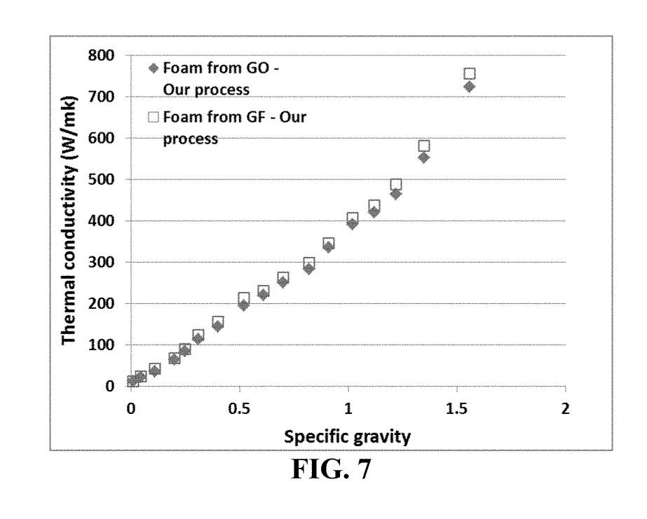

Shown in FIG. 5(A) and FIG. 6(A) are the thermal conductivity values vs. specific gravity of the GO suspension-derived foam, prior art mesophase pitch-derived graphite foam, and Ni foam template-assisted CVD graphene foam. These data clearly demonstrate the following unexpected results:
1) GO-derived graphene foams produced by the presently invented process exhibit significantly higher thermal conductivity as compared to both mesophase pitch-derived graphite foam and Ni foam template-assisted CVD graphene, given the same physical density.
2) This is quite surprising in view of the notion that CVD graphene is essentially pristine graphene that has never been exposed to oxidation and should have exhibited a much higher thermal conductivity compared to graphene oxide (GO). GO is known to be highly defective (having a high defect population and, hence, low conductivity) even after the oxygen-containing functional groups are removed via conventional thermal or chemical reduction methods. These exceptionally high thermal conductivity values observed with the GO-derived graphene foams herein produced are much to our surprise. A good thermal dissipation capability is essential to the prevention of thermal run-away and explosion, a most serious problem associated with rechargeable lithium-ion batteries.
3) FIG. 6(A) presents the thermal conductivity values over comparable ranges of specific gravity values to allow for calculation of specific conductivity (conductivity value, W/mK, divided by physical density value, g/cm³) for all three graphitic foam materials based on the slopes of the curves (approximately straight lines at different segments). These specific conductivity values enable a fair comparison of thermal conductivity values of these three types of graphitic foams given the same amount of solid graphitic material in each foam. These data provide an index of the intrinsic conductivity of the solid portion of the foam material. These data clearly indicate that, given the same amount of solid material, the presently invented GO-derived foam is intrinsically most conducting, reflecting a high level of graphitic crystal perfection (larger crystal dimensions, fewer grain boundaries and other defects, better crystal orientation, etc.). This is also unexpected.
4) As shown in FIG. 7, the specific conductivity values of the presently invented GO- and GF-derived foam exhibit values from 250 to 500 W/mK per unit of specific gravity; but those of the other two foam materials are typically lower than 250 W/mK per unit of specific gravity.

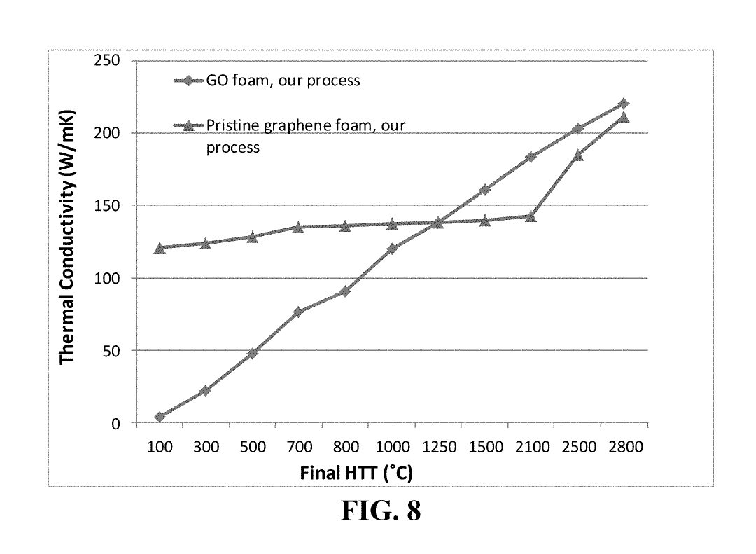

Summarized in FIG. 8 are thermal conductivity data for a series of GO-derived graphene foams and a series of pristine graphene derived foams, both plotted over the final (maximum) heat treatment temperatures. These data indicate that the thermal conductivity of the GO foams is highly sensitive to the final heat treatment temperature (HTT). Even when the HTT is very low, clearly some type of graphene merging or crystal perfection reactions are already activated. The thermal conductivity increases monotonically with the final HTT. In contrast, the thermal conductivity of pristine graphene foams remains relatively constant until a final HTT of approximately 2,500° C. is reached, signaling the beginning of a re-crystallization and perfection of graphite crystals. There are no functional groups in pristine graphene, such as —COOH in GO, that enable chemical linking of graphene sheets at relatively low HTTs. With a HTT as low as 1,250° C., GO sheets can merge to form significantly larger graphene sheets with reduced grain boundaries and other defects. Even though GO sheets are intrinsically more defective than pristine graphene, the presently invented process enables the GO sheets to form graphene foams that outperform pristine graphene foams. This is another unexpected result.

### Example 9: Preparation of Graphene Oxide (GO) Suspension from Natural Graphite and Preparation of Subsequent GO Foams

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions. We observed that GO sheets form a liquid crystal phase when GO sheets occupy a weight fraction>3% and typically from 5% to 15%.

By dispensing and coating the GO suspension on a polyethylene terephthalate (PET) film in a slurry coater and removing the liquid medium from the coated film we obtained a thin film of dried graphene oxide. Several GO film samples were then subjected to different heat treatments, which typically include a thermal reduction treatment at a first temperature of 100° C. to 500° C. for 1-10 hours, and at a second temperature of 1,500° C.-2,850° C. for 0.5-5 hours. With these heat treatments, also under a compressive stress, the GO films were transformed into graphene foam.

### Example 10: Graphene Foams from Hydrothermally Reduced Graphene Oxide

For comparison, a self-assembled graphene hydrogel (SGH) sample was prepared by a one-step hydrothermal method. In a typical procedure, the SGH can be easily prepared by heating 2 mg/mL of homogeneous graphene oxide (GO) aqueous dispersion sealed in a Teflon-lined autoclave at 180° C. for 12 h. The SGH containing about 2.6% (by weight) graphene sheets and 97.4% water has an electrical conductivity of approximately 5×10⁻³ S/cm. Upon drying and heat treating at 1,500° C., the resulting graphene foam exhibits an electrical conductivity of approximately 1.5×10⁻¹ S/cm, which is 2 times lower than those of the presently invented graphene foams produced by heat treating at the same temperature.

FIG. 5(B) and FIG. 6(B) show the thermal conductivity values of the presently invented GO suspension-derived foam, GO foam produced via prior art sacrificial plastic bead template-assisted process, and hydrothermally reduced GO graphene foam. Most surprisingly, given the same starting GO sheets, the presently invented process produces the highest-performing graphene foams. Electrical conductivity data summarized in FIG. 5(C) are also consistent with this conclusion. These data further support the notion that, given the same amount of solid material, the presently invented GO suspension deposition (with stress-induced orientation) and subsequent heat treatments give rise to a graphene foam that is intrinsically most conducting, reflecting a highest level of graphitic crystal perfection (larger crystal dimensions, fewer grain boundaries and other defects, better crystal orientation, etc. along the pore walls).

It is of significance to point out that all the prior art processes for producing graphite foams or graphene foams appear to provide macro-porous foams having a physical density in the range of approximately 0.2-0.6 g/cm³ only with pore sizes being typically too large (e.g. from 20 to 300 μm) for most of the intended applications. In contrast, the instant invention provides processes that generate graphene foams having a density that can be as low as 0.01 g/cm³ and as high as 1.7 g/cm³. The pore sizes can be varied between meso-scaled (2-50 nm) up to macro-scaled (1-500 μm) depending upon the contents of non-carbon elements and the amount/type of blowing agent used. This level of flexibility and versatility in designing various types of graphene foams is unprecedented and un-matched by any prior art process.

### Example 11: Preparation of Graphene Foams from Graphene Fluoride

Several processes have been used by us to produce GF, but only one process is herein described as an example. In a typical procedure, highly exfoliated graphite (HEG) was prepared from intercalated compound C₂F.xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, ethanol, 1-propanol, 2-propanol, 1-butanol, tert-butanol, isoamyl alcohol) and subjected to an ultrasound treatment (280 W) for 30 min, leading to the formation of homogeneous yellowish dispersions. Five minutes of sonication was enough to obtain a relatively homogenous dispersion, but longer sonication times ensured better stability. Upon casting on a glass surface with the solvent removed, the dispersion became a brownish film formed on the glass surface. When GF films were heat-treated, fluorine was released as gases that helped to generate pores in the film. In some samples, a physical blowing agent (N₂ gas) was injected into the wet GF film while being cast. These samples exhibit much higher pore volumes or lower foam densities. Without using a blowing agent, the resulting graphene fluoride foams exhibit physical densities from 0.35 to 1.38 g/cm³. When a blowing agent was used (blowing agent/GF weight ratio from 0.5/1 to 0.05/1), a density from 0.02 to 0.35 g/cm³ was obtained. Typical fluorine contents are from 0.001% (HTT=2,500° C.) to 4.7% (HTT=350° C.), depending upon the final heat treatment temperature involved.

FIG. 7 presents a comparison in thermal conductivity values of the graphene foam samples derived from GO and GF (graphene fluoride), respectively, as a function of the specific gravity. It appears that the GF foams, in comparison with GO foams, exhibit higher thermal conductivity values at comparable specific gravity values. Both deliver impressive heat-conducting capabilities, being the best among all known foamed materials.

### Example 12: Preparation of Graphene Foams from Nitrogenated Graphene

Graphene oxide (GO), synthesized in Example 9, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained with graphene:urea mass ratios of 1:0.5, 1:1 and 1:2 are designated as NGO-1, NGO-2 and NGO-3 respectively and the nitrogen contents of these samples were 14.7, 18.2 and 17.5 wt % respectively as found by elemental analysis. These nitrogenated graphene sheets remain dispersible in water. The resulting suspensions were then cast, dried, and heat-treated initially at 200-350° C. as a first heat treatment temperature and subsequently treated at a second temperature of 1,500° C. The resulting nitrogenated graphene foams exhibit physical densities from 0.45 to 1.28 g/cm³. Typical nitrogen contents of the foams are from 0.01% (HTT=1,500° C.) to 5.3% (HTT=350° C.), depending upon the final heat treatment temperature involved.

### Example 13: Characterization of Various Graphene Foams and Conventional Graphite Foam

The internal structures (crystal structure and orientation) of several dried GO layers, and the heat-treated films at different stages of heat treatments were investigated using X-ray diffraction. The X-ray diffraction curve of natural graphite typically exhibits a peak at approximately 2θ=26°, corresponds to an inter-graphene spacing (d₀₀₂) of approximately 0.3345 nm. Upon oxidation, the resulting GO shows an X-ray diffraction peak at approximately 2θ=12°, which corresponds to an inter-graphene spacing (d₀₀₂) of approximately 0.7 nm. With some heat treatment at 150° C., the dried GO compact exhibits the formation of a hump centered at 22°, indicating that it has begun the process of decreasing the inter-graphene spacing due to the beginning of chemical linking and ordering processes. With a heat treatment temperature of 2,500° C. for one hour, the d₀₀₂ spacing has decreased to approximately 0.336, close to 0.3354 nm of a graphite single crystal.

With a heat treatment temperature of 2,750° C. for one hour, the d₀₀₂ spacing is decreased to approximately to 0.3354 nm, identical to that of a graphite single crystal. In addition, a second diffraction peak with a high intensity appears at 2θ=55° corresponding to X-ray diffraction from (004) plane. The (004) peak intensity relative to the (002) intensity on the same diffraction curve, or the I(004)/I(002) ratio, is a good indication of the degree of crystal perfection and preferred orientation of graphene planes. The (004) peak is either non-existing or relatively weak, with the I(004)/I(002) ratio<0.1, for all graphitic materials heat treated at a temperature lower than 2,800° C. The I(004)/I(002) ratio for the graphitic materials heat treated at 3,000-3,250° C. (e.g. highly oriented pyrolytic graphite, HOPG) is in the range of 0.2-0.5. In contrast, a graphene foam prepared with a final HTT of 2,750° C. for one hour exhibits a I(004)/I(002) ratio of 0.78 and a Mosaic spread value of 0.21, indicating a practically perfect graphene single crystal with a good degree of preferred orientation.

The “mosaic spread” value is obtained from the full width at half maximum of the (002) reflection in an X-ray diffraction intensity curve. This index for the degree of ordering characterizes the graphite or graphene crystal size (or grain size), amounts of grain boundaries and other defects, and the degree of preferred grain orientation. A nearly perfect single crystal of graphite is characterized by having a mosaic spread value of 0.2-0.4. Some of our graphene foams have a mosaic spread value in this range of 0.2-0.4 when produced using a final heat treatment temperature no less than 2,500° C.

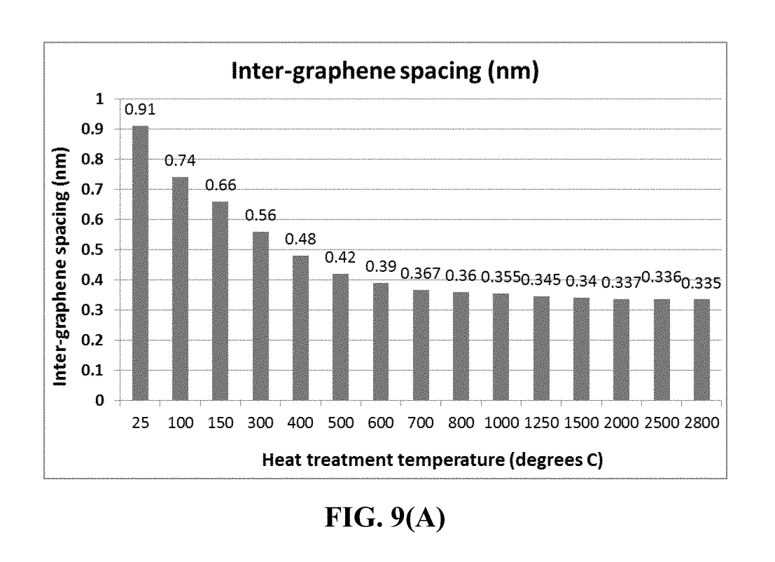

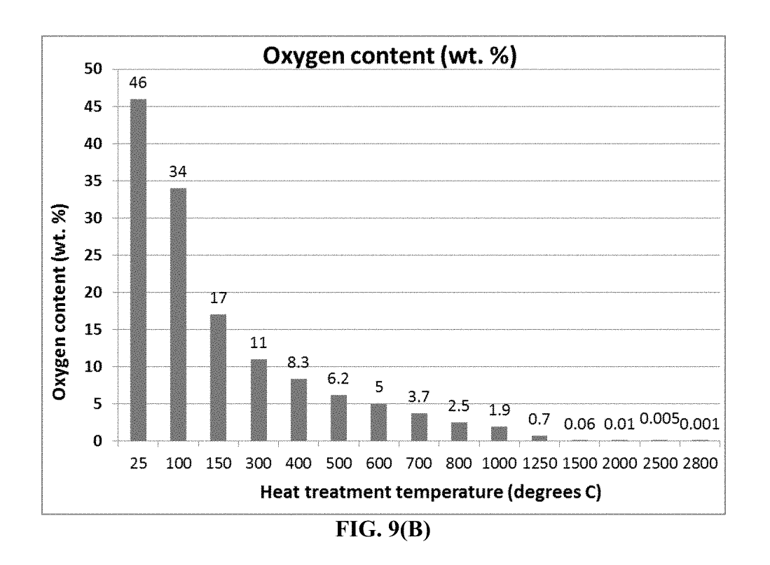

The inter-graphene spacing values of both the GO suspension-derived samples obtained by heat treating at various temperatures over a wide temperature range are summarized in FIG. 9(A). Corresponding oxygen content values in the GO suspension-derived unitary graphene layer are shown in FIG. 9(B).

It is of significance to point out that a heat treatment temperature as low as 500° C. is sufficient to bring the average inter-graphene spacing in GO sheets along the pore walls to below 0.4 nm, getting closer and closer to that of natural graphite or that of a graphite single crystal. The beauty of this approach is the notion that this GO suspension strategy has enabled us to re-organize, re-orient, and chemically merge the planar graphene oxide molecules from originally different graphite particles or graphene sheets into a unified structure with all the graphene planes now being larger in lateral dimensions (significantly larger than the length and width of the graphene planes in the original graphite particles). A potential chemical linking mechanism is illustrated in FIG. 4. This has given rise to exceptional thermal conductivity and electrical conductivity values.

### Example 13: Electrochemical Performance of Various Rechargeable Lithium-Ion Battery Cells

For electrochemical testing, both pouch cells and coin cells were prepared. The presently invented layers of graphene foam-protected niobium-based composite metal oxide particles can be directly used as an electrode. The conventional working electrodes were prepared by mixing 85 wt % active material (e.g. composite metal oxide primary particles only), 7 wt. % acetylene black (Super-P), and 8 wt % polyvinylidene fluoride binder resin (PVDF, 5 wt. % solid content) dissolved in N-methyl-2-pyrrolidinoe (NMP). After coating the slurries on a sheet of carbon fiber mat, the electrodes were dried at 120° C. in vacuum for 2 h to remove the solvent before pressing. A variety of cathode active materials were used in preparing the pouch cells (full cells). The CV measurements were carried out using an electrochemical workstation at a scanning rate of 1 mV/s.

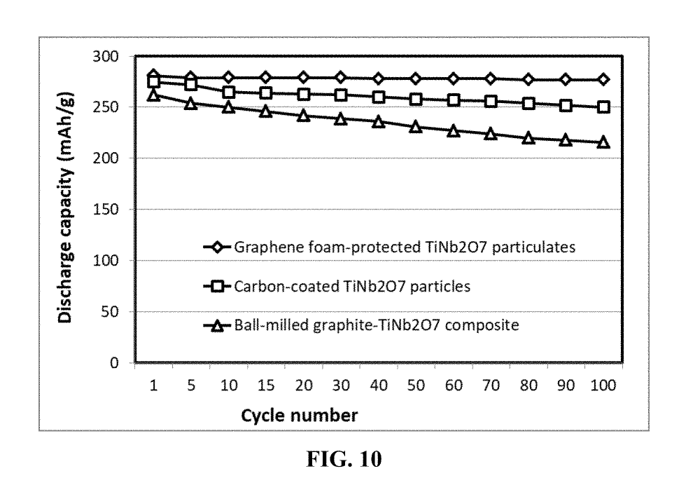

Shown in FIG. 10 are the specific capacity values of 3 lithium secondary cells: one containing an anode of graphene foam-protected TiNb₂O₇ particles/graphene, a cell containing an anode of carbon-coated TiNb₂O₇ nanocrystals, and a cell containing ball-milled graphite-TiNb₂O₇ particles, each plotted as a function of the number of charge/discharge cycles. It is clear that carbon coating is not sufficiently effective in reducing the continued decomposition of electrolyte and, hence, continued capacity decay. Graphene foam protection provides the best anode protection approach to ensure a long cycle life.

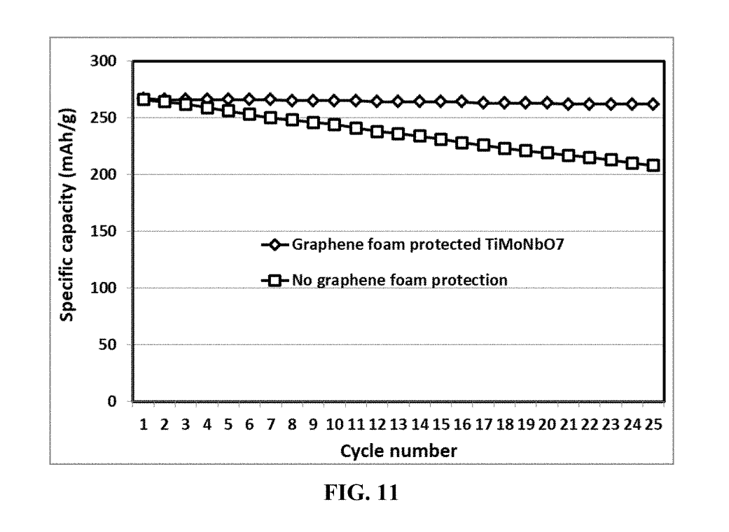

FIG. 11 shows the specific capacity of 2 lithium cells: a cell containing an anode of graphene foam-protected TiMoNbO₇ particles and a cell containing non-protected TiMoNbO₇ particles, each plotted as a function of the number of charge/discharge cycles. These data show the outstanding cycle stability afforded to by the presently invented graphene foam protection approach.

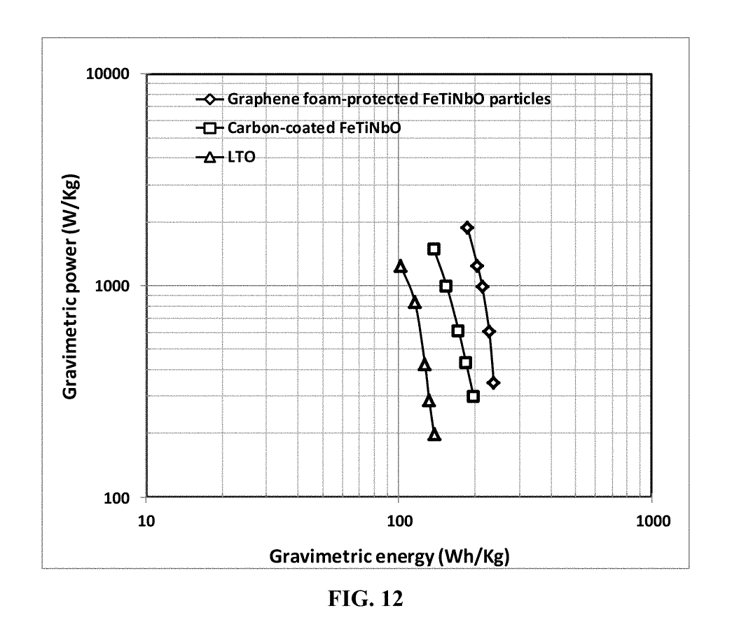

Summarized in FIG. 12 are the Ragone plots (power density vs. energy density) of three cells: a cell containing an anode of graphene foam-protected hybrid particulates of Fe_{0.1}Ti_{0.8}Nb_{2.1}O₇, a cell containing an anode of carbon-coated Fe_{0.1}Ti_{0.8}Nb_{2.1}O₇, and a cell containing an anode of Li₄Ti₅O₁₂. These anode materials all intercalate lithium ions at an electrochemical potential of 1.1-1.5 V relative to Li⁺/Li and, thus, are all presumably capable of stable charging/discharging. However, we have observed that these materials, without graphene foam protection, tend to exhibit a gas-forming phenomenon during repeated charges/discharges, as reflected by the swelling or bulging of the pouch cell. This is presumably caused by repeated electrochemical reduction of the electrolyte, resulting in the formation of volatile gas molecules as a by-product of such side reactions. The presently invented graphene foam protection approach not only surprisingly overcomes this problem (leading to significantly longer cycle life), but also enables the cell to deliver excellent energy density and power density given the same types of anode and cathode active materials.

We claim:

1. An anode or negative electrode layer for a lithium battery, said anode layer comprising multiple particles of an anode active material and a solid graphene foam composed of multiple pores and pore walls, wherein
a. said pore walls contain a pristine graphene material, a non-pristine graphene material, or combinations thereof;
b. said anode active material contains fine particles of a niobium-containing composite metal oxide, having a size from 1 nm to 10 μm, and is in an amount from 0.5% to 99% by weight based on the total weight of said graphene foam and said anode active material combined; and
c. said multiple pores are lodged with said particles of the anode active material and said graphene foam to prevent direct physical contact of said particles with a liquid component of an electrolyte in said lithium battery.

2. The anode layer of claim 1, wherein said solid graphene foam has a density from 0.01 to 1.7 g/cm³, a specific surface area from 50 to 2,000 m²/g, a thermal conductivity of at least 100 W/mK per unit of specific gravity, and/or an electrical conductivity no less than 1,000 S/cm per unit of specific gravity.

3. The anode layer of claim 1, wherein said solid graphene foam contains oxygen, fluorine, chlorine, bromine, iodine, nitrogen, hydrogen, or boron from 0.01% to 2.0% by weight.

4. The anode layer of claim 1, wherein said graphene solid foam has an oxygen content or non-carbon content less than 1% by weight, and said pore walls have an inter-graphene spacing less than 0.35 nm, a thermal conductivity of at least 250 W/mK per unit of specific gravity, and/or an electrical conductivity no less than 2,500 S/cm per unit of specific gravity.

5. The anode layer of claim 1, wherein said solid graphene foam exhibits a degree of graphitization from 80% to 100% and/or a mosaic spread value from 0.4 to 1.

6. The anode layer of claim 1, wherein said solid graphene foam contains pores having a pore size from 20 nm to 500 nm and some of said pores exhibit continuous open porosity.

7. The anode layer of claim 1, wherein said pores have a pore size from 2 nm to 100 nm.

8. The anode layer of claim 1, wherein said pore walls contain stacked graphene planes having an inter-plane spacing d₀₀₂ from 0.3354 nm to 0.36 nm as measured by X-ray diffraction.

9. The anode layer of claim 1, wherein said pore walls contain stacked graphene planes having an inter-graphene spacing from 0.334 nm to 0.34 nm, a mosaic spread value from 0.6 to 1, a thermal conductivity from 100 W/mK to 400 W/mK per unit of specific gravity, and/or an electrical conductivity from 1,000 S/cm to 4,000 S/cm per unit of specific gravity.

10. The anode layer of claim 1, wherein the pore walls contain stacked graphene planes having an inter-graphene spacing less than 0.337 nm and a mosaic spread value less than 1.0.

11. The anode layer of claim 1, wherein the pore walls contain a three dimensional network of interconnected graphene planes.

12. The anode layer of claim 1, wherein said niobium-containing composite metal oxide is selected from the group consisting of TiNb₂O₇, LiₓTiNb₂O₇ (0<x≤5), LiₓM_{(1-y)}Nb_{y}Nb₂O_{(7+δ)} (wherein 0≤x≤6, 0≤y≤1, −1≤δ≤1, and M=Ti or Zr), TiₓNb_{y}O₇ (0.5≤y/x<2.0), TiNbₓO_{(2+5x/2)} (1.9≤x<2.0), MₓTi₍₁₋₂ₓ₎Nb₍₂₊ₓ₎O_{(7+δ)}(wherein 0≤x≤0.2, −0.3≤δ≤0.3, and M=a trivalent metal selected from Fe, Ga, Mo, Ta, V, Al, B, and a mixture thereof), MₓTi₍₂₋₂ₓ₎Nb₍₁₀₊ₓ₎O_{(29+δ)} (wherein 0≤x≤0.4, −0.3≤δ≤0.3, and M=a trivalent metal selected from Fe, Ga, Mo, Al, B, and a mixture thereof), MₓTiNb₂O₇ (0≤x<0.5, and M=B, Na, Mg, Al, Si, S, P, K, Ca, Mo, W, Cr, Mn, Co, Ni, and Fe), TiNb₂₋ₓTaₓO_{y} (0≤x<2, 7≤y≤10), Ti₂Nb₁₀₋ᵥTaᵥO_{w} (0≤v<2, 27≤y≤29), LiₓTi_{(1-y)}M1_{y}Nb_{(2-z)}M2_{z}O_{(7+δ)} (wherein 0≤x≤5, 0≤y≤1, 0≤z≤2, −0.3≤δ≤0.3, M1=Zr, Si, and Sn, and M2=V, Ta, and Bi), P-doped versions thereof, B-doped versions thereof, carbon-coated versions thereof, and combinations thereof.

13. The anode layer of claim 1, wherein said anode active material is in the form of nanoparticle, nanowire, nanofiber, nanotube, nanosheet, nanobelt, nanoribbon, or nanocoating having a thickness or diameter less than 100 nm.

14. The anode layer of claim 13, wherein said anode active material has a dimension less than 20 nm.

15. The anode layer of claim 13, further comprising a conductive protective coating, selected from a carbon material, electronically conductive polymer, conductive metal oxide, conductive metal coating, or a lithium-conducting material, which is deposited onto or wrapped around said nanoparticle, nanowire, nanofiber, nanotube, nanosheet, nanobelt, nanoribbon, or nanocoating.

16. The anode layer of claim 1, further comprising a carbon or graphite material disposed therein, wherein said carbon or graphite material is in electronic contact with or deposited onto particles of said anode active material.

17. The anode layer of claim 16, wherein said carbon or graphite material is selected from polymeric carbon, amorphous carbon, chemical vapor deposition carbon, coal tar pitch, petroleum pitch, mesophase pitch, carbon black, coke, acetylene black, activated carbon, fine expanded graphite particle with a dimension smaller than 100 nm, artificial graphite particle, natural graphite particle, or a combination thereof.

18. The anode layer of claim 1, wherein said niobium composite metal oxide is prelithiated prior to being formed into said anode layer or prior to being incorporated into said lithium battery.

19. The anode layer of claim 1, further comprising a lithium-conducting coating.

20. The anode layer of claim 1, which is in a continuous-length roll sheet form having a thickness no greater than 300 μm and a length of at least 2.

21. A lithium battery containing the anode or negative electrode layer as defined in claim 1, a cathode or positive electrode, and an electrolyte in ionic contact with said anode and said cathode.

22. The lithium battery of claim 21, further containing a cathode current collector in electronic contact with said cathode.

23. The lithium battery of claim 21, further containing an anode current collector in electronic contact with said anode.

24. The lithium battery of claim 21, wherein said graphene foam operates as an anode current collector to collect electrons from said anode active material during a charge of said lithium battery, which contains no separate or additional current collector.

25. A process for producing the anode layer of claim 1, said process comprising:
(a) preparing a graphene dispersion having multiple particles of said anode active material containing a niobium-containing composite metal oxide and multiple sheets of a starting graphene material dispersed in a liquid medium, wherein said starting graphene material is selected from a pristine graphene material, a non-pristine graphene and combinations thereof and wherein said dispersion contains an optional blowing agent having a blowing agent-to-graphene material weight ratio from 0/1.0 to 1.0/1.0;
(b) dispensing and depositing said graphene dispersion onto a surface of a supporting substrate to form a wet layer of graphene/anode active material mixture, wherein said dispensing and depositing procedure includes subjecting said graphene dispersion to an orientation-inducing stress;
(c) partially or completely removing said liquid medium from the wet layer of graphene/anode active material to form a dried layer of mixture material;
(d) heat treating the dried layer of mixture material at a first heat treatment temperature selected from 80° C. to 1,500° C. at a desired heating rate sufficient to induce volatile gas molecules from said non-carbon elements or blowing agent to activate for producing said anode layer; and
(e) optionally heat treating the anode layer at a second heat treatment temperature higher than said first heat treatment temperature for a length of time sufficient for obtaining an anode layer wherein said pore walls contain stacked graphene planes having an inter-plane spacing d₀₀₂ from 0.3354 nm to 0.36 nm and a content of non-carbon elements less than 2% by weight, wherein the second heat treatment temperature includes at least a temperature selected from (A) 1,500-2,100° C. or (B) 2,100-3,200° C.

26. The process of claim 25, wherein said graphene material contains pristine graphene and said dispersion contains a blowing agent having a blowing agent-to-pristine graphene weight ratio from 0.01/1.0 to 1.0/1.0.

27. The process of claim 25, wherein said blowing agent is a physical blowing agent, a chemical blowing agent, a mixture thereof, a dissolution-and-leaching agent, or a mechanically introduced blowing agent.

28. The process of claim 25, wherein said graphene material is selected from the group of non-pristine graphene materials consisting of graphene oxide, reduced graphene oxide, graphene fluoride, graphene chloride, graphene bromide, graphene iodide, hydrogenated graphene, nitrogenated graphene, chemically functionalized graphene, and combinations thereof.

29. The process of claim 25, which is a roll-to-roll process wherein said steps (b) and (c) include feeding said supporting substrate from a feeder roller to a deposition zone, continuously or intermittently depositing said graphene dispersion onto a surface of said supporting substrate to form said wet layer of graphene material thereon, drying said wet layer of graphene material to form the dried layer of graphene material, and collecting said dried layer of graphene material deposited on said supporting substrate on a collector roller

30. The process of claim 25, wherein said step (d) of heat treating the dried layer of graphene material at a first heat treatment temperature is conducted under a compressive stress.

31. The process of claim 25, further comprising compression during or after heat treatment to reduce a thickness, a pore size, or a porosity level of said solid graphene foam.

32. The process of claim 25, wherein said graphene dispersion contains graphene oxide having an oxygen content from 5% by weight to 50% by weight.
